(19) United States
(12) Patent Application Publication
(10) Pub. No.: US 2025/0227408 A1
(43) Pub. Date: Jul. 10, 2025

(54) GLASS DIAPHRAGM EQUIPPED WITH EXCITER, CONTROL SYSTEM FOR GLASS DIAPHRAGM EQUIPPED WITH EXCITER, AND CONTROL PROGRAM FOR GLASS DIAPHRAGM EQUIPPED WITH EXCITER

(71) Applicant: AGC Inc., Tokyo (JP)

(72) Inventors: Kento SAKURAI, Tokyo (JP); Jun AKIYAMA, Tokyo (JP)

(73) Assignee: AGC Inc., Tokyo (JP)

(21) Appl. No.: 19/092,866

(22) Filed: Mar. 27, 2025

Related U.S. Application Data
(63) Continuation of application No. PCT/JP2023/033157, filed on Sep. 12, 2023.

(30) Foreign Application Priority Data
Sep. 29, 2022 (JP) 2022-157157

(51) Int. Cl. H04R 1/24; H04R 3/00; H04R 7/10; H04R 9/02

(52) U.S. Cl. CPC H04R 1/24; H04R 3/00; H04R 7/10; H04R 9/025; H04R 2307/023

(57) ABSTRACT

An exciter-equipped glass diaphragm, includes: a glass plate structure; and a first exciter and a second exciter, which are attached to the glass plate structure, in which, when a lowest resonant frequency of the first exciter is F1(0) (Hz), and a lowest resonant frequency of the second exciter is F2(0) (Hz), the exciter-equipped glass diaphragm satisfies: 3≤|F1(0)−F2(0)|≤100 (Hz).

### CROSS-REFERENCE TO RELATED APPLICATIONS

This application is a continuation application of International Application No. PCT/JP2023/033157 filed Sep. 12, 2023 the disclosure of which is incorporated herein by reference in its entirety. Further, this application claims priorities from Japanese Patent Application No. 2022-157157 filed Sep. 29, 2022, the disclosure of which is incorporated herein by reference in their entirety.

### TECHNICAL FIELD

The present disclosure relates to a glass diaphragm equipped with an exciter, a control system for a glass diaphragm equipped with an exciter, and a control program for a glass diaphragm equipped with an exciter.

### RELATED ART

In recent years, techniques that enable a glass plate to function as a speaker by vibrating the glass plate have been investigated.

Japanese Patent Application Laid-Open No. 2021-180486 discloses an example in which a predetermined sound is generated by vibrating vehicle upholstery and vehicle glass windows, and as an example, a configuration is disclosed in which one or more acoustic generators are disposed at the front glass window to obtain predetermined acoustic output characteristics.

However, an acoustic generator such as an actuator has an intrinsic lowest resonant frequency F(0), and since resistance is higher in the vicinity of the lowest resonant frequency than at other frequencies, there is a delay in response time in the vicinity of the lowest resonant frequency and it becomes difficult to accurately reproduce sounds in the vicinity of the lowest resonant frequency, which is a problem. For this reason, it has been difficult to secure a wide acoustic range that enables reproduction since, for example, it has been necessary to design an acoustic generator to cover an acoustic range excluding the vicinity of the lowest resonant frequency.

### SUMMARY

The present disclosure aims to provide a glass diaphragm equipped with an exciter, a control system for a glass diaphragm equipped with an exciter, and a control program for a glass diaphragm equipped with an exciter, with which acoustic properties can be obtained over a wide acoustic range that has favorable reproducibility for acoustic ranges in the vicinity of the exciter's intrinsic lowest resonant frequency.

The glass diaphragm equipped with an exciter according to the present disclosure has a glass plate structure; and a first exciter and a second exciter, which are attached to the glass plate structure, in which, when a lowest resonant frequency of the first exciter is F1(0) (Hz), and a lowest resonant frequency of the second exciter is F2(0) (Hz), the exciter-equipped glass diaphragm satisfies: 3≤|F1(0)−F2(0)|≤100 (Hz).

A control system for an exciter-equipped glass diaphragm according to the present disclosure includes; an exciter-equipped glass diaphragm, including a glass plate structure, and a first exciter and a second exciter, which are attached to the glass plate structure, in which, when a lowest resonant frequency of the first exciter is F1(0) (Hz), and a lowest resonant frequency of the second exciter is F2(0) (Hz), the exciter-equipped glass diaphragm satisfies: 3≤|F1(0)−F2(0)|≤100 (Hz); and a control device configured to control a voltage input to each of the first exciter and the second exciter so as to: reduce the voltage input to the first exciter required for the first exciter to generate vibration at a frequency in the vicinity of the lowest resonant frequency F1(0) of the first exciter to lower than the voltage input to the second exciter required for the second exciter to generate vibration at a frequency in the vicinity of the lowest resonant frequency F1(0) of the first exciter, and, in conjunction with reducing the voltage input to the first exciter, increase the voltage input to the second exciter corresponding to the lowest resonant frequency F1(0) of the first exciter so as to compensate for an amount of reduction from vibration at a frequency in the vicinity of the lowest resonant frequency F1(0) of the first exciter that was planned to be generated by the first exciter; and reduce the voltage input to the second exciter corresponding to the vicinity of the lowest resonant frequency F2(0) of the second exciter required for the second exciter to generate vibration at a frequency in the vicinity of the lowest resonant frequency F2(0) of the second exciter to lower than the voltage input to the first exciter corresponding to the vicinity of the lowest resonant frequency F2(0) of the second exciter required for the first exciter to generate vibration at a frequency in the vicinity of the lowest resonant frequency F2(0) of the second exciter, and, in conjunction with reducing the voltage input to the second exciter, increase the voltage input to the first exciter corresponding to the lowest resonant frequency F2(0) of the second exciter so as to compensate for an amount of reduction from vibration at a frequency in the vicinity of the lowest resonant frequency F2(0) of the second exciter that was planned to be generated by the first exciter.

A control program for an exciter-equipped glass diaphragm according to the present disclosure causes a computer to execute processing including: with respect to a first exciter and a second exciter attached to a glass plate structure configuring an exciter-equipped glass diaphragm, which, when respective lowest resonant frequencies of the first exciter and the second exciter are F1(0) and F2(0), satisfy: 3≤|F1(0)−F2(0)|≤100 (Hz), reducing the voltage input to the first exciter required for the first exciter to generate vibration at a frequency in the vicinity of the lowest resonant frequency F1(0) of the first exciter to lower than the voltage input to the second exciter required for the second exciter to generate vibration at a frequency in the vicinity of the lowest resonant frequency F1(0) of the first exciter, and, in conjunction with reducing the voltage input to the first exciter, increasing the voltage input to the second exciter corresponding to the lowest resonant frequency F1(0) of the first exciter so as to compensate for an amount of reduction from vibration at a frequency in the vicinity of the lowest resonant frequency F1(0) of the first exciter that was planned to be generated by the first exciter; and reducing the voltage input to the second exciter corresponding to the vicinity of the lowest resonant frequency F2(0) of the second exciter required for the second exciter to generate vibration at a frequency in the vicinity of the lowest resonant frequency F2(0) of the second exciter to lower than the voltage input to the first exciter corresponding to the vicinity of the lowest resonant frequency F2(0) of the second exciter required for the first exciter to generate vibration at a frequency in the vicinity of the lowest resonant frequency F2(0) of the second exciter, and, in conjunction with reducing the voltage input to the second exciter, increasing the voltage input to the first exciter corresponding to the lowest resonant frequency F2(0) of the second exciter so as to compensate for an amount of reduction from vibration at a frequency in the vicinity of the lowest resonant frequency F2(0) of the second exciter that was planned to be generated by the first exciter.

In the glass diaphragm equipped with an exciter, the control system for a glass diaphragm equipped with an exciter, and the control program for a glass diaphragm equipped with an exciter of the present disclosure, acoustic properties can be obtained over a wide acoustic range that has favorable reproducibility for acoustic ranges in the vicinity of the exciter's intrinsic lowest resonant frequency.

### BRIEF DESCRIPTION OF DRAWINGS

FIG. 1 is a schematic diagram of a glass diaphragm equipped with an exciter.

FIG. 2 is a cross-sectional view of a glass diaphragm equipped with an exciter as viewed from a side.

FIG. 3 is a diagram illustrating an example of a frequency characteristic of an exciter.

FIG. 4 is a diagram showing an example of a signal input to an exciter.

FIG. 5A is a diagram showing an example of a vibration waveform of 40 Hz generated by an exciter.

FIG. 5B is a diagram showing an example of a vibration waveform of 50 Hz generated by an exciter.

FIG. 5C is a diagram showing an example of a vibration waveform of 60 Hz generated by an exciter.

FIG. 6 is a diagram illustrating an example of frequency characteristics of two exciters.

FIG. 7 is a diagram showing an example of output characteristics of two exciters.

FIG. 8 is a diagram showing an example of the configuration of a glass diaphragm control system.

FIG. 9 is a flowchart showing an example of the flow of control processing for a glass diaphragm equipped with an exciter.

FIG. 10A is a diagram showing an attachment example of an exciter to a glass plate structure.

FIG. 10B is a diagram showing another attachment example of an exciter to a glass plate structure.

FIG. 10C is a diagram showing another attachment example of an exciter to a glass plate structure.

FIG. 10D is a diagram showing another attachment example of an exciter to a glass plate structure.

FIG. 11 is a diagram showing an attachment example of two exciters to the same mount.

FIG. 12 is a diagram showing an example of a mount.

FIG. 13 is a diagram showing an example of a vehicle.

FIG. 14A is a diagram showing an attachment example of exciters to roof glass.

FIG. 14B is a diagram showing another attachment example of exciters to roof glass.

FIG. 14C is a diagram showing an attachment example of exciter pairs to roof glass.

FIG. 15A is a diagram showing an attachment example of exciters to back door glass.

FIG. 15B is a diagram showing another attachment example of exciters to back door glass.

FIG. 15C is a diagram showing an attachment example of attaching exciters to four corners of back door glass.

FIG. 15D is a diagram showing an attachment example of exciter pairs to back door glass.

FIG. 15E is a diagram showing an attachment example of attaching exciter pairs and an exciter to back door glass.

FIG. 15F is a diagram showing an attachment example of three types of exciter to back door glass.

### DETAILED DESCRIPTION

Hereinafter, the present embodiment is explained with reference to the drawings. It should be noted that the same reference numerals are appended to the same configuration elements and the same processing throughout the drawings, and repeated explanation thereof is omitted.

### <Configuration of Exciter-Equipped Glass Diaphragm 1>

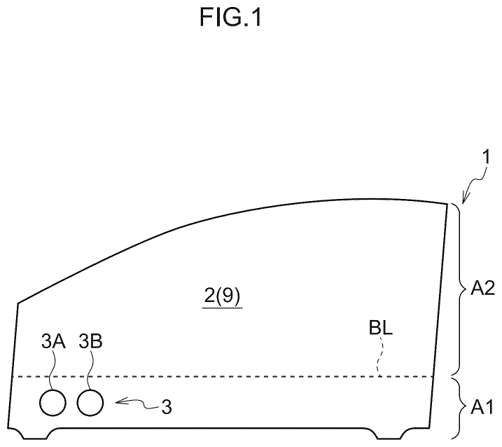

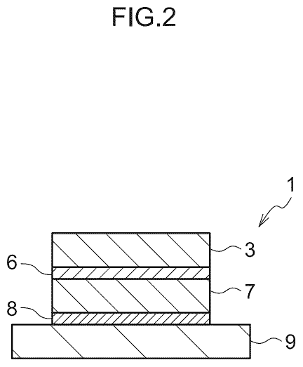

FIG. 1 is a schematic diagram of an exciter-equipped glass diaphragm 1, as viewed toward a main surface. Further, FIG. 2 is a cross-sectional view of the exciter-equipped glass diaphragm 1 as viewed from a side.

As shown in FIG. 1, the exciter-equipped glass diaphragm 1 of the present embodiment includes a glass vibrating plate 2 and an exciter 3, and two exciters 3 are attached to the glass vibrating plate 2. Hereinafter, when the exciters are explained separately from each another, one exciter 3 is referred to as “exciter 3A” and the other exciter 3 is referred to as “exciter 3B.” When there is no need to distinguish between the individual exciters, they are simply referred to as “exciter 3”.

In the present embodiment, the configuration of the exciter-equipped glass diaphragm 1 will be described using an example in which the exciter-equipped glass diaphragm 1 is applied to the window glass of a vehicle; however, the application target of the exciter-equipped glass diaphragm 1 is not limited to vehicle window glass. The exciter-equipped glass diaphragm 1 can be applied to window glass of buildings, structures, and mobile bodies that form a space inside which people may enter, such as window glass for houses and window glass for soundproof rooms.

The glass vibrating plate 2 includes a glass plate structure 9. While the glass plate structure 9 of the present embodiment may be configured by a single plate glass, from the viewpoint of improving the acoustic effect of the glass vibrating plate 2, it is preferable that the glass vibrating plate 2 be configured by laminated glass.

FIG. 1 shows an example in which the glass plate structure 9 is attached to a door of a vehicle and is used as a side glass that separates the interior space of the vehicle from exterior space.

The exciter 3 is attached to an area A1 below a belt line BL of the glass plate structure 9. The downward direction of the glass plate structure 9 refers to the direction of gravity along the surface of the glass plate structure 9 when the glass plate structure 9 is attached to the door of the vehicle. When the glass sheet structure 9 is used as a slidable side glass, the belt line BL corresponds to the lower edge of the area A2, which is an opening area when the side glass is attached to a vehicle door in a fully closed state.

The configuration of the exciter-equipped glass diaphragm 1 is described in detail with reference to FIG. 2.

### (Glass Plate Structure 9)

In the present embodiment, the glass plate structure 9 is formed of transparent or translucent inorganic glass. However, there is no limitation to this, and the glass plate structure 9 may be formed of organic glass. Examples of organic glass include PMMA (polymethyl methacrylate) resin, PC (polycarbonate) resin, PS (polystyrene) resin, PET (polyethyleneterephthalate) resin, PVC (polyvinylchloride) resin, and cellulosic resin.

In addition, in a case in which the glass plate structure 9 is formed of laminated glass including plural glass plates, an example of such a configuration is one in which an intermediate layer is sandwiched between a pair of glass plates; however, a configuration having three or more glass plates may also be used. The thickness of the laminated glass is preferably 1.0 mm or more, more preferably 2.0 mm or more, and even more preferably 3.0 mm or more. This allows the laminated glass to have sufficient strength. Further, the thickness of each of the glass plates configuring the laminated glass is preferably 5.0 mm or less, more preferably 3.0 mm or less, and even more preferably 2.0 mm or less. Furthermore, the thickness of each of the glass plates configuring the laminated glass is preferably 0.1 mm or more, more preferably 0.5 mm or more, and even more preferably 1.0 mm or more. The pair of glass plates may have the same thickness or different thicknesses.

The intermediate layer that configures the laminated glass is formed of transparent polyvinyl butyral (PVB) or ethylene-vinyl acetate copolymer (EVA) resin films, silicone (PDMS), polyurethane, fluorine, polyethylene terephthalate, or polycarbonate resin films, or the like. Further, a material that enhances sound insulation, and a material that absorbs ultraviolet rays and infrared rays, or the like may be added to the intermediate layer. Furthermore, the intermediate layer is not limited to the above-mentioned resin films, but may also be, for example, a gel layer, an adhesive layer, a liquid layer, a sol layer, or a grease layer. In a case in which the above-mentioned resin films are used, for example, the thickness of the intermediate layer may be set, for example, to from 1 nm to 1.0 mm, from 0.1 mm to 0.9 mm, or from 0.2 mm to 0.8 mm.

### (Mount 7 and Resin Layer 8)

A mount 7 is fixed to one main surface of the glass plate structure 9 via a resin layer 8. In the following description, for convenience, the direction from the glass plate structure 9 toward the mount 7 is referred to as the “upward direction,” and the opposite direction is referred to as the “downward direction”. However, the vertical direction here may be a different direction from the vertical direction when the glass vibrating plate 2 is attached to a frame or the like. It should be noted that the mount 7 is not essential, and the exciter 3 may be attached to one of the main surfaces of the glass plate structure 9 without interposing the mount 7.

The resin layer 8 has the same outer diameter as the mount 7, and is provided over the entire lower surface of the mount 7. As the resin layer 8, an adhesive, a pressure-sensitive adhesive, or the like may be used as appropriate. As the pressure-sensitive adhesive, a pressure-sensitive adhesive tape formed in a sheet shape can be used.

The resin layer 8 in the present embodiment may be configured to include an acrylic resin adhesive, for example, but is not limited thereto. Furthermore, the mount 7 and the glass plate structure 9 may be mechanically fixed to each other. For example, when the glass plate structure 9 is a side glass, in the region A1, a holder for sliding (not shown) attached to the lower edge of the glass plate structure 9 (see FIG. 1) may be used also as a part of the mount 7 and fixed, whereby the exciter 3 can be prevented from falling off.

### (Connection Part 6)

As shown in FIG. 2, a connection part 6 is provided at the opposite side of the mount 7 from the side of the glass plate structure 9. In the present embodiment, the glass plate structure 9 is disposed on the surface of the mount 7 at the lower side, and the connection part 6 is disposed on the surface of the mount 7 at the upper side.

An exciter 3 that causes the glass plate structure 9 to vibrate is attached to the connection part 6. As an example, the connection part 6 of the present embodiment may configure the outer shell of the exciter 3. For example, the exciter 3 may be assembled in a state in which its bottom surface is open, and the open bottom surface may be closed by the connection part 6. That is, a part of the connection part 6 may be configured as a lid part that covers a part of the exciter 3. Further, the exciter 3 may be attached to the connection part 6 mechanically with screws, bolts, or the like, or may be attached to the connection part 6 with an adhesive or the like.

### (Exciter 3)

The exciter 3 is connected to a power source (not shown) and vibrates the glass plate structure 9 in accordance with the magnitude of an input voltage. The exciter 3 of the present embodiment is, for example, configured as a voice coil motor including a coil and a magnetic circuit, with one of the coil or the magnetic circuit being fixed to the mount 7 and the other being arranged movably relative to the mount 7. When current flows through the coil, vibration is generated by the interaction between the coil and the magnetic circuit, causing the glass plate structure 9 to vibrate via the mount 7. The exciter 3 is not limited to a voice coil motor, and may be an actuator other than a voice coil motor, such as a piezoelectric actuator, as long as it is an actuator capable of transmitting the desired vibration to the glass plate structure 9.

While, in the present embodiment, an example in which the exciter-equipped glass diaphragm 1 is applied to a side glass of a vehicle is explained, it may be used, for example, in a windshield, rear window, a front bench window, a rear quarter window, or the roof glass of a vehicle. In particular, in a case in which a fixed window glass other than a side glass having an area A1 and having a constantly concealed area is used as the exciter-equipped glass diaphragm 1, the exciter 3 may be attached to a light-shielding region formed by providing a shielding layer of black ceramic or the like that blocks visible light at the periphery of the window glass. In this case, the area across which the exciter 3 blocks the view through the opening of the fixed window glass can be reduced, which is preferable, and furthermore, it is more preferable that the exciter 3 be disposed so as to completely overlap with the light-shielding region.

<Control Principle of Glass Diaphragm 1 Equipped with Exciter>

Noise that occurs outside the interior space of a vehicle, such as road noise caused by a vehicle traveling on a road, and noise from the engine or motor that generates the vehicle's driving force, mainly enters the interior space of the vehicle through the glass plate structure 9.

Therefore, if vibration having a frequency distribution in the opposite phase to the frequency distribution of the noise entering the vehicle interior space is generated by the exciter 3, the noise will be canceled, and therefore, noise in the vehicle interior space is reduced compared to before the exciter 3 is driven.

This method of reducing noise is called active noise canceling. With active noise cancelling, since the exciter 3 is driven to generate vibration in the opposite phase to the noise in the glass plate structure 9, the response time of the exciter 3 is an important indicator. The response time of the exciter 3 is an example of a characteristic of the exciter 3 that is expressed by the time from when the exciter 3 starts to vibrate until the exciter starts to vibrate in response to an input signal. The shorter the time until vibration in response to an input signal begins, the better the responsiveness.

In addition, since the vibration of the glass plate structure 9 by the exciter 3 generates sound in the opposite phase to the noise, the vibration of the glass plate structure 9 by the exciter 3 is also represented by sound pressure.

Further, each object has multiple resonant frequencies F(N). Here, “N” is an integer equal to or greater than 0 and represents the degree of the resonant frequency. Specifically, the resonant frequency F(0) represents the lowest resonant frequency (also called the zero-degree resonant frequency). Further, the resonant frequency F(N) for N equal to or greater than 1 represents an Nth-degree resonant frequency having a frequency N+1 times the lowest resonant frequency F(0).

The resonant frequency F(N) is the frequency at which the resonance of an object assumes a maximum value when a waveform having that frequency is input to the object. The resonance of an object is manifested by changes in vibration, voltage, current, and resistance values. For example, if an object is configured by an electric circuit, when an input signal corresponding to a frequency in the vicinity of the resonant frequency F(N) is input to the electric circuit, at least one of the voltage, current, and resistance values that represent the characteristics of the electric circuit assumes an extreme value. The vicinity of the resonant frequency F(N) is a frequency band including the resonant frequency F(N), and this is a frequency band in which a specific physical quantity representing the characteristics of an object that change owing to an input signal, can be considered to change at the same level as the physical quantity at the resonant frequency F(N).

Naturally, each exciter 3 also has a resonant frequency F(N). Of the resonant frequencies F(N), the frequency that most strongly induces a resonance phenomenon in an object is the lowest resonant frequency F(0). The resonance phenomenon caused by an Nth-degree resonant frequency (where N is 1 or more) is smaller than the resonance phenomenon caused by the lowest resonant frequency F(0). Therefore, hereinafter, the characteristics of the exciter 3 are described focusing on the lowest resonant frequency F(0) of the exciter 3.

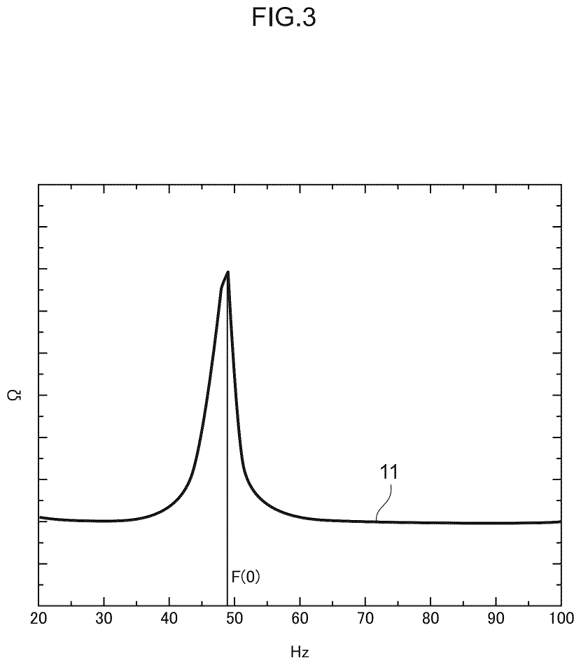

FIG. 3 is a diagram illustrating an example of a frequency characteristic of the exciter 3. The horizontal axis of the frequency characteristic 11 in FIG. 3 represents the frequency (Hz), and the vertical axis represents the resistance value (Ω) of the exciter 3.

When an input signal corresponding to a frequency in the vicinity of the lowest resonant frequency F(0) is input to the exciter 3, the resistance value of the exciter 3 in the vicinity of the lowest resonant frequency F(0) increases significantly compared to the resistance value of the exciter 3 at other frequencies. If the magnitude of the current supplied to the exciter 3 is constant, as the resistance value of the exciter 3 increases, the response time of the exciter 3 deteriorates compared to the response time of the exciter 3 at other frequencies.

As exemplified in FIG. 3, the lowest resonant frequency F(0) of the exciter 3 having the frequency characteristic 11 is 48 Hz. Therefore, the exciter 3 having the frequency characteristic 11 illustrated in FIG. 3 has poorer responsiveness to input signals corresponding to frequencies around 48 Hz compared to other frequencies.

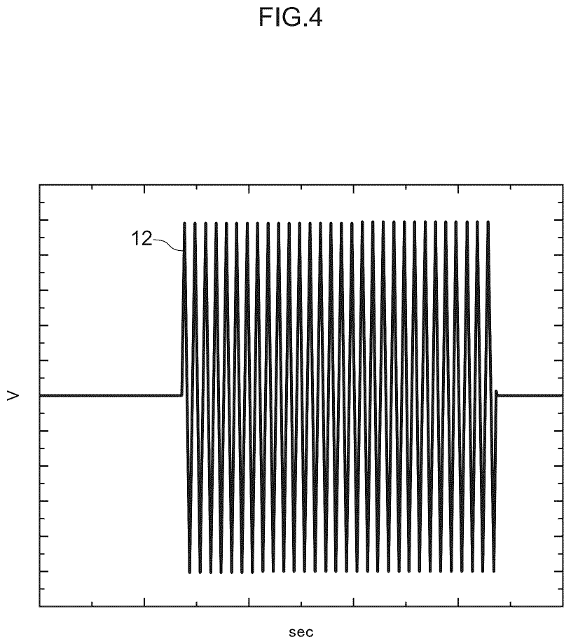

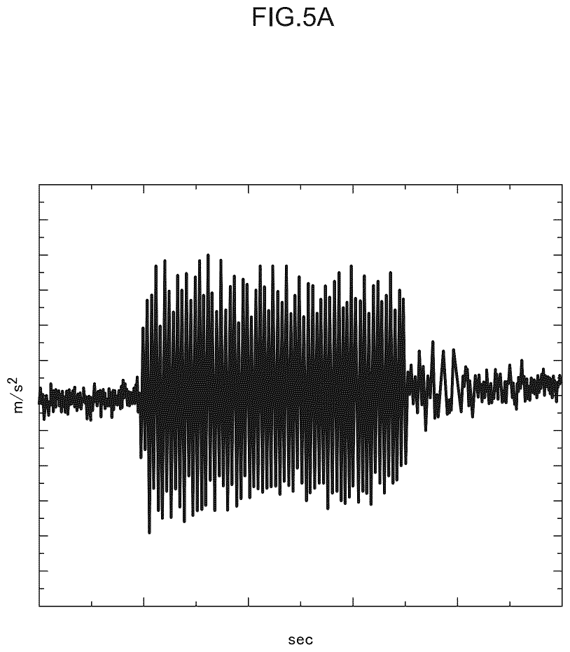

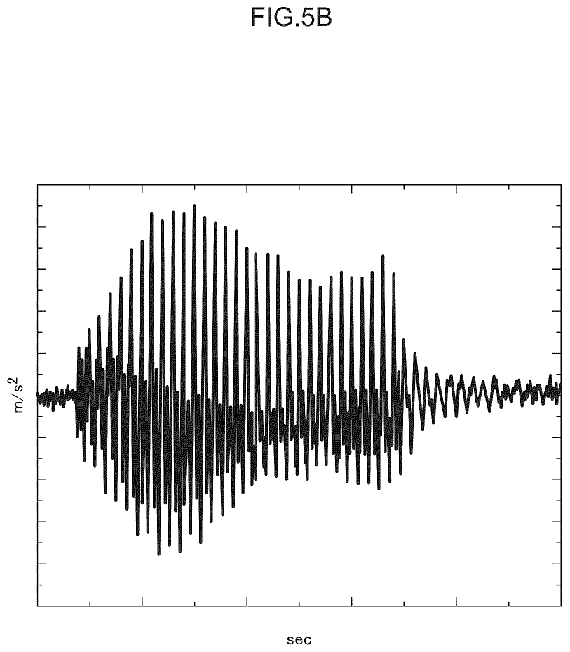

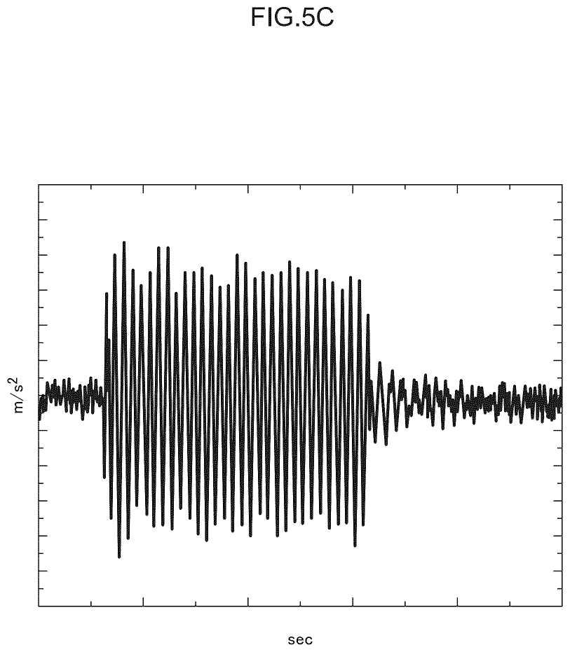

The responsiveness of the exciter 3 is specifically explained with reference to FIGS. 4, 5A, 5B, and 5C.

FIG. 4 is a diagram showing an example of a signal input to the exciter 3 having the frequency characteristic 11 shown in FIG. 3. FIGS. 5A, 5B, and 5C are diagrams showing examples of vibration waveforms in cases in which the input signal shown in FIG. 4 is input to the exciter 3 having the frequency characteristic 11 shown in FIG. 3.

The vibration waveform examples shown in FIGS. 5A, 5B, and 5C are waveforms measured by an acceleration sensor (NP-3200, manufactured by Ono Sokki Co., Ltd.; not shown in the drawings) attached to a different main surface of the glass plate structure 9 from the main surface to which the exciter 3 is attached. Specifically, a drive signal is output to the exciter 3 from a real-time acoustic vibration analysis system (DS-3200, manufactured by Ono Sokki Co., Ltd.; not shown in the drawings), and the measurement signal from the acceleration sensor is measured by the above-mentioned real-time acoustic vibration analysis system. Here, the real-time acoustic vibration analysis system can output drive signals of various waveforms, such as sine waves, burst waves, and impulse waves, having any given frequency and voltage, to the exciter 3. In a case in which there is one exciter 3, it is preferable to attach the acceleration sensor at a position facing the exciter 3 with the glass plate structure 9 interposed therebetween. When there are plural exciters 3, it is preferable to attach the acceleration sensor at a position as equidistant as possible from each of the exciters 3.

As shown in FIG. 4, a tone burst signal 12 was used as the signal input to the exciter 3. FIG. 5A is an example of a vibration waveform of 40 Hz generated by the exciter 3, FIG. 5B is an example of a vibration waveform of 50 Hz generated by the exciter 3, and FIG. 5C is an example of a vibration waveform of 60 Hz generated by the exciter 3. The horizontal axis of each vibration waveform example in FIGS. 5A, 5B, and 5C represents time (sec), and the vertical axis represents acceleration (m/s²).

According to the vibration waveform examples of the exciter 3 shown in FIGS. 5A and 5C, from the start of vibration due to the tone burst signal 12, vibration is generated with an acceleration proportional to the magnitude of the voltage of the tone burst signal 12. Further, referring to the vibration waveform example of the exciter 3 shown in FIG. 5B, at the start of vibration due to the tone burst signal 12, a “delay” phenomenon is observed in which a vibration smaller than that corresponding to the magnitude of the voltage of the tone burst signal 12 occurs, after which the vibration becomes larger.

In this way, the response time of the exciter 3 in the vicinity of the lowest resonant frequency F(0) is worse than the response time in frequency bands other than in the vicinity of the lowest resonant frequency F(0). This deterioration (delay) in response time in the vicinity of the lowest resonant frequency F(0) is more prominent than the delay in response time at resonant frequencies equal to or higher than resonant frequency F(1). Therefore, in order to achieve acoustic reproducibility over a wide acoustic range including low frequencies, it is extremely important to achieve the effect of an improvement in responsiveness in the vicinity of the lowest resonant frequency F(0).

It is known that the lowest resonant frequency F(0) of the exciter 3 varies depending on the characteristics of the components configuring the exciter 3. The lowest resonant frequency F(0) of the exciter 3 is expressed, for example, by equation (1). In equation (1), “K” is a spring constant representing the strength of the repulsive force of the exciter 3, and “M” is the mass of the vibrating part of the exciter 3 connected to the glass plate structure 9 via a spring. Various types of vibrating parts of the exciter 3 exist, such as those in which the housing configuring the outer shell of the exciter 3 vibrates, those in which the magnet vibrates, and those in which both of these vibrate.

$$\begin{matrix}Equation 1 & \\ F ( 0 ) = \frac{1}{2 π} \sqrt{\frac{K}{M}} & ( 1 )\end{matrix}$$

Equation (1) means that the lowest resonant frequency F(0) of the exciter 3 changes as a result of changing at least one of the spring constant K or the mass M of the vibrating part. Therefore, as shown in FIG. 1, the deterioration in the responsiveness of the exciter 3 in the vicinity of the lowest resonant frequency F(0) is resolved by attaching plural exciters 3 with different lowest resonant frequencies F(0) to one glass plate structure 9. Here, the plural exciters 3 may be attached to one of the main surfaces of the glass plate structure 9, or the exciter 3A may be attached to one main surface, and the exciter 3B may be attached to the other main surface. However, it is preferable to attach plural exciters 3 to (only) one of the main surfaces, since this allows the height of the exciter-equipped glass diaphragm 1 to be kept low.

Hereinafter, the lowest resonant frequency F(0) of the exciter 3A in FIG. 1 is referred to as the “lowest resonant frequency F1(0)”, and the lowest resonant frequency F(0) of the exciter 3B is referred to as the “lowest resonant frequency F2(0)”. Furthermore, when it is not necessary to distinguish between the lowest resonant frequency F1(0) and the lowest resonant frequency F2(0), the lowest resonant frequency is expressed as F(0) as previously.

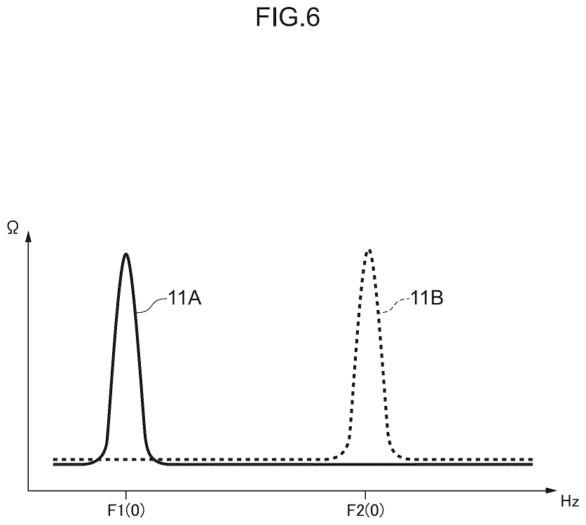

FIG. 6 is a diagram showing an example of frequency characteristics of the exciter 3A and the exciter 3B. In FIG. 6, the horizontal axis represents frequency (Hz), and the vertical axis represents the internal impedance (Ω) of the exciter 3. Moreover, the frequency characteristic 11A in FIG. 6 represents an example of the frequency characteristic of the exciter 3A. Moreover, the frequency characteristic 11B in FIG. 6 represents an example of the frequency characteristic of the exciter 3B. In the example shown in FIG. 6, the lowest resonant frequency F1(0) is smaller than the lowest resonant frequency F2(0), but the lowest resonant frequency F1(0) may be greater than the lowest resonant frequency F2(0). For the exciter 3A and the exciter 3B, exciters 3 having a lowest resonant frequency F(0) of 200 Hz or less are used. The reason that exciters 3 having a lowest resonant frequency F(0) of 200 Hz or less are used is that the glass plate structure 9 does not easily vibrate at frequencies below the lowest resonant frequency F(0). For example, if the lowest resonant frequency F(0) of the exciter 3 is 500 Hz, it becomes difficult to vibrate the glass plate structure 9 at a frequency less than 500 Hz. Therefore, it is preferable to use an exciter 3 having a lowest resonant frequency F(0) of 200 Hz or less from the viewpoint of generating sounds in the lowest possible bass range using the exciter 3. Furthermore, the lowest resonant frequency F(0) of the exciter 3 used in the exciter-equipped glass diaphragm 1 is preferably 120 Hz or less, and more preferably 100 Hz or less.

Since, when the glass plate structure 9 is laminated glass, it is designed to have a high damping coefficient and to suppress resonant vibration, the lower and upper limits of the lowest resonant frequency F(0) of the exciter 3 used in the exciter-equipped glass diaphragm 1 are not particularly defined. For example, the lower limit of the lowest resonant frequency F(0) of the exciter 3 used in the exciter-equipped glass diaphragm 1 may be 180 Hz or less, 150 Hz or less, 120 Hz or less, or 100 Hz or less. Furthermore, it may be 20 Hz, which is the lower limit of the human audible range, or even lower.

When the lowest resonant frequency F1(0) of the exciter 3A is different from the lowest resonant frequency F2(0) of the exciter 3B, while lowering the voltage input to the exciter 3A in the vicinity of the lowest resonant frequency F1(0), the voltage input to the exciter 3B is increased. As a result, vibration having a frequency in the vicinity of the lowest resonant frequency F1(0) is obtained relatively by the exciter 3B, and the linearity of the sound quality can be maintained. Since the lowest resonant frequency F2(0) of the exciter 3B is different from the lowest resonant frequency F1(0) of the exciter 3A, the deterioration in the responsiveness of the exciter 3A in the vicinity of the lowest resonant frequency F1(0) can be compensated for by the exciter 3B.

Further, while lowering the voltage input to the exciter 3B in the vicinity of the lowest resonant frequency F2(0), the voltage input to the exciter 3A is increased. As a result, vibration having a frequency in the vicinity of the lowest resonant frequency F2(0) is obtained relatively by the exciter 3A, and the linearity of the sound quality can be maintained. Since the lowest resonant frequency F1(0) of the exciter 3A is different from the lowest resonant frequency F2(0) of the exciter 3B, the deterioration in the responsiveness of the exciter 3B in the vicinity of the lowest resonant frequency F2(0) can be compensated for by the exciter 3A.

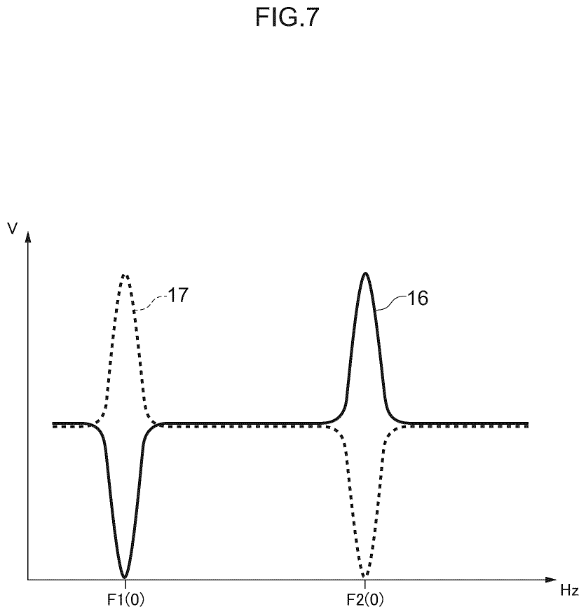

FIG. 7 is a diagram showing an example of the output characteristics of the exciter 3A and the exciter 3B in a case in which the input voltage is adjusted as described above. The curve 16 in FIG. 7 shows an example of the output characteristics of the exciter 3A. Moreover, the curve 17 in FIG. 7 shows an example of the output characteristics of the exciter 3B.

At the lowest resonant frequency F1(0), the input voltage of the exciter 3A is lowered while the input voltage of the exciter 3B is increased, as a result of which vibration corresponding to the lowest resonant frequency F1(0) is mainly generated by the exciter 3B. In addition, at the lowest resonant frequency F2(0), the input voltage of the exciter 3B is lowered while the input voltage of the exciter 3A is increased, as a result of which vibration corresponding to the lowest resonant frequency F2(0) is mainly generated by the exciter 3A.

If the difference between the lowest resonant frequency F1(0) of the exciter 3A and the lowest resonant frequency F2(0) of the exciter 3B is too small, the vicinity of the lowest resonant frequency F1(0) and the vicinity of the lowest resonant frequency F2(0) will overlap, and it becomes difficult to improve responsiveness by using exciters 3 having a different lowest resonant frequencies F(0). Further, if the difference between the lowest resonant frequency F1(0) of the exciter 3A and the lowest resonant frequency F2(0) of the exciter 3B is too large, the lowest resonant frequency F1(0) or the lowest resonant frequency F2(0) will exceed 200 Hz, and the processing speed in the control device 20 will decrease. Therefore, it is preferable that the difference between the lowest resonant frequency F1(0) of the exciter 3A and the lowest resonant frequency F2(0) of the exciter 3B satisfies 3 Hz≤|F1(0)−F2(0)|≤100 Hz. Moreover, the difference more preferably satisfies 4 Hz≤|F1(0)−F2(0)|≤50 Hz, and yet more preferably satisfies 5 Hz≤|F1(0)−F2(0)|≤20 Hz.

<Configuration of Control System 10 for Glass Diaphragm Equipped with Exciter>

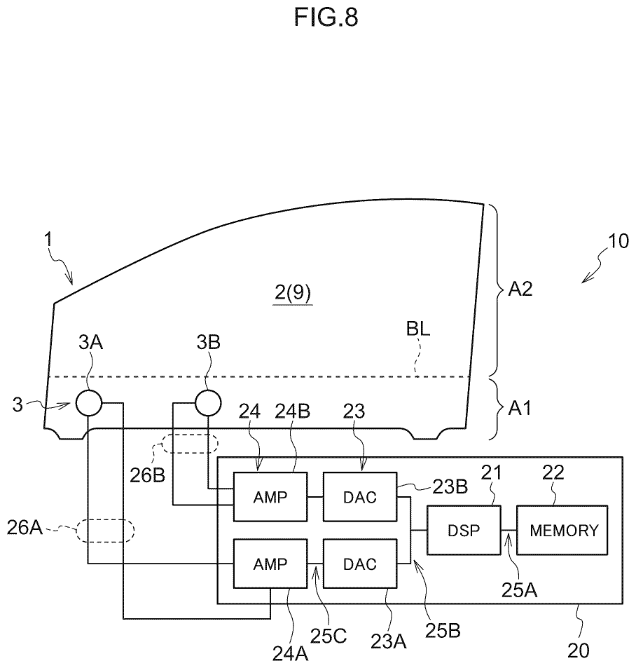

FIG. 8 is a diagram showing an example of the configuration of a control system 10 for a glass diaphragm equipped with exciter. The exciter-equipped glass diaphragm control system 10, which controls the input voltage in the vicinity of the lowest resonant frequency F(0) as described above with respect to the exciter 3A and the exciter 3B, includes the exciter-equipped glass diaphragm 1, and a control device 20.

The control device 20 includes a digital signal processor (DSP) 21, a memory 22, a digital-to-analog converter (DAC) 23, and an amplifier (AMP) 24.

The DSP 21 of the control device 20 is an example of a processor that controls the voltages input to the exciters 3A and 3B. The DSP 21 is connected to the memory 22 via a first internal bus 25A, and is connected to the DAC 23 via a second internal bus 25B.

The memory 22 is configured by a RAM and a non-volatile memory. The RAM is an example of a storage device used as a temporary workspace for the DSP 21. The nonvolatile memory is an example of a storage device in which stored information is maintained even if the power supplied to the nonvolatile memory is cut off, and for example, a semiconductor memory is used.

The DAC 23 outputs a voltage corresponding to the value of the voltage input to the exciter 3, which is specified as a digital value by the DSP 21. For example, if the maximum value of the voltage input to the exciter 3 is 100 V and the maximum value of the voltage output from the DAC 23 is 1 V, in a case in which 50 V is specified as the voltage input to the exciter 3, the voltage corresponding to the value of the voltage input to the exciter 3 is 0.5 V. The input voltage range of the exciter 3 is from 0.01 V to 100 V. In this way, the DSP 21 converts digital information into analog information using the DAC 23. The DSP 21 is provided for each exciter 3. In the present embodiment, the DAC 23 for the exciter 3A is represented as DAC 23A, and the DAC 23 for the exciter 3B is represented as DAC 23B.

The AMP 24 amplifies the voltage input from the DAC 23 via a third internal bus 25C to the value of the voltage input to the exciter 3 designated by the DSP 21. Similarly to the DAC 23, the AMP 24 is provided for each exciter 3. In the present embodiment, the AMP 24 for the exciter 3A is represented as AMP 24A, and the AMP 24 for the exciter 3B is represented as AMP 24B.

The voltage amplified by the AMP 24A is input to the exciter 3A via a first connection cable 26A. Furthermore, the voltage amplified by the AMP 24B is input to the exciter 3B via a second connection cable 26B.

By this, the input voltage designated by the DSP 21 is input to the exciters 3A and 3B. The control device 20 is configured by a computer including, for example, a DSP 21 and a memory 22.

### <Control Processing of Exciter-Equipped Glass Diaphragm 1>

Next, processing for controlling the exciter-equipped glass diaphragm, which is executed by the control device 20, is described.

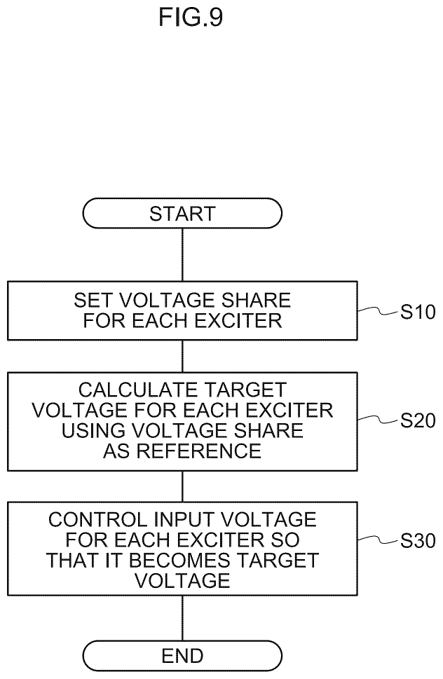

FIG. 9 is a flowchart showing an example of a flow of exciter-equipped glass diaphragm control processing executed by a DSP 21 of a control device 20 in a case in which vibration having a frequency in the vicinity of the lowest resonant frequency F(0) is generated at the exciter 3.

A control program for the exciter-equipped glass diaphragm, which defines the control processing for the exciter-equipped glass diaphragm, is stored in advance in a non-volatile memory configuring the memory 22 of the control device 20, for example. The DSP 21 of the control device 20 reads the control program for the exciter-equipped glass diaphragm stored in the non-volatile memory, and executes the processing for controlling the exciter-equipped glass diaphragm.

In the following, as an example, a case in which vibration of a frequency in the vicinity of the lowest resonant frequency F1(0) of the exciter 3A is generated at the exciter 3 is described.

First, in step S10, the DSP 21 sets the voltage share for each exciter 3 in accordance with a predetermined share ratio. For example, in the case of frequencies other than the resonant frequency, it is possible to achieve favorable acoustic performance by using corrections such as equalization and band pass filters without significantly changing the share ratio between the exciters 3A and 3B. The share ratio and each voltage share are stored in advance in a non-volatile memory that configures the memory 22, for example. The share ratio and each voltage share are parameters that can be changed by the user. The share ratio is not limited to a value that equalizes the sound pressure and acceleration shared by each exciter 3 and, for example, the value of the share ratio for the exciter 3A and the exciter 3B may be 1:1.5 or 2:1, such that a difference is established in the voltage applied for each frequency. Here, as an example, a case will be described in which the share ratios of the exciter 3A and the exciter 3B are set to equal ratios.

In step S20, the DSP 21 reduces the voltage share of the exciter 3A to below the voltage share of the exciter 3B. Further, the DSP 21 increases the voltage share of the exciter 3B so as to compensate for the reduction in the voltage share of the exciter 3A. For example, if the voltage share of the exciter 3A and the exciter 3B is 5 V each, the DSP 21 increases the voltage share of the exciter 3B by 4 V in addition to reducing the voltage share of the exciter 3A by 4 V. As a result, the voltage share of the exciter 3A becomes 1 V, and the voltage share of the exciter 3B becomes 9 V. The updated voltage share of each exciter 3 calculated in this manner by the processing of step S20 is referred to as the target voltage. The DSP 21 controls the target voltage of each exciter 3 so that it falls within the range of 0.01 V to 100 V.

Here, as an example, the amount of variation from the initial voltage share of the exciter 3A and the amount of variation from the initial voltage share of the exciter 3B are set to the same value; however, it is not necessary that the amount of variation from the initial voltage share in each exciter 3 be the same. In particular, when applying vibration to glass, points that are physically susceptible to vibration and points that are difficult to vibrate are determined not only by the performance of the exciter 3 but also by the vibration position, and equal ratio correction does not necessarily produce correct results at all positions and frequencies. The DSP 21 may set the target voltages of the exciters 3A and 3B so as to fall within an allowable range in which the difference between the amount of variation from the initial voltage share of the exciter 3A and the amount of variation from the initial voltage share of the exciter 3B can be regarded as having the same magnitude.

Specifically, for example, in a case in which the allowable range is 0.5 V, if the absolute value of the difference between the amount of variation from the initial voltage share of each exciter 3 is 0.5 V or less, the target voltage of the exciter 3B becomes an input voltage that compensates for the extent of the reduction in the initial voltage share of the exciter 3A. The voltage values constituting the allowable range can be set by the user, and are stored in advance in a non-volatile memory that configures the memory 22, for example.

When the acceleration of the exciter 3A at the lowest resonant frequency F1(0) (Hz) is A1₍₀₎(m/sec²), the acceleration of the exciter 3A at the lowest resonant frequency F1(0)−3 (Hz) is A1₍₀₎₋₃(m/sec²), and the acceleration of the exciter 3A at the lowest resonant frequency F1(0)+3 (Hz) is A1₍₀₎₊₃(m/sec²), it is preferable that the DSP 21 sets a target voltage that satisfies equation (2).

$$\begin{matrix}Equation 2 & \\ \begin{matrix}\vert A {1}_{( 0 ) - 3} - A {1}_{( 0 )} \vert ≦ 10 \\ \vert A {1}_{( 0 ) + 3} - A {1}_{( 0 )} \vert ≦ 10\end{matrix} \} & ( 2 )\end{matrix}$$

In addition, in equation (2), the value on the right side—i.e., the difference in acceleration shown on the left side—is preferably 5 m/sec² or less, and is more preferably 3 m/sec² or less. In addition, the difference between the target voltage of the DSP 21 when the vibration frequency of the exciter 3A is the lowest resonant frequency F1(0) [Hz] and the target voltage of the DSP 21 when the vibration frequency of the exciter 3A is the lowest resonant frequency F1(0)−3 (Hz) or the lowest resonant frequency F1(0)+3 (Hz) is preferably 20 V or less, more preferably 10 V or less, still more preferably 5 V or less, even more preferably 3 V or less, and particularly preferably 1 V or less. In addition, the difference between the target voltage of the DSP 21 when the vibration frequency of the exciter 3A is the lowest resonant frequency F1(0)+3 (Hz) and the target voltage of the DSP 21 when the exciter 3A has the lowest resonant frequency F1(0)−3 [Hz] is preferably 20 V or less, more preferably 10 V or less, still more preferably 5 V or less, even more preferably 3 V or less, and particularly preferably 1 V or less.

Further, when the acceleration of the exciter 3B at the lowest resonant frequency F2(0) (Hz) is A2₍₀₎ (m/sec²), the acceleration of the exciter 3B at the lowest resonant frequency F2(0)−3 (Hz) is A2₍₀₎₋₃ (m/sec²), and the acceleration of the exciter 3B at the lowest resonant frequency F2(0)+3 (Hz) is A2₍₀₎₊₃ (m/sec²), it is preferable that the DSP 21 sets a target voltage that satisfies equation (3).

$$\begin{matrix}Equation 3 & \\ \begin{matrix}\vert A {2}_{( 0 ) - 3} - A {2}_{( 0 )} \vert ≦ 10 \\ \vert A {2}_{( 0 ) + 3} - A {2}_{( 0 )} \vert ≦ 10\end{matrix} \} & ( 3 )\end{matrix}$$

Here, in equation (3), the value on the right side—i.e., the difference in acceleration shown on the left side—is preferably 5 m/sec² or less, and is more preferably 3 m/sec² or less. In addition, the difference between the target voltage of the DSP 21 when the exciter 3B has the lowest resonant frequency F2(0) (Hz) and the target voltage of the DSP 21 when the exciter 3B has the lowest resonant frequency F2(0)−3 (Hz) or the lowest resonant frequency F2(0)+3 (Hz) is preferably 20 V or less, more preferably 10 V or less, still more preferably 5 V or less, even more preferably 3 V or less, and particularly preferably 1 V or less. In addition, the difference between the target voltage of the DSP 21 when the exciter 3B has the lowest resonant frequency F2(0)+3 (Hz) and the target voltage of the DSP 21 when the exciter 3B has the lowest resonant frequency F2(0)−3 [Hz] is preferably 20 V or less, more preferably 10 V or less, still more preferably 5 V or less, even more preferably 3 V or less, and particularly preferably 1 V or less.

In step S30, the DSP 21 controls the input voltage of each of the exciters 3 so that the input voltage of each of the exciters 3 becomes the target voltage calculated in step S20, and the exciter-equipped glass diaphragm control processing shown in FIG. 9 is ended.

There are two types of share ratios for each exciter 3: a share ratio that is set in advance (referred to as a “default share ratio”) and a share ratio that is calculated sequentially (referred to as a “sequential share ratio”).

For example, in a case in which active noise cancellation of a sound such as music, whose power spectrum, indicating the change in sound pressure level for each frequency band over time, is known in advance, is performed using the exciter-equipped glass diaphragm 1, an inverted power spectrum is obtained from the power spectrum by inverting the power spectrum. The sound represented by the inverted power spectrum becomes a cancellation sound having a frequency distribution in the opposite phase to the sound represented by the power spectrum. Therefore, a default share ratio for the exciter 3 can be created in advance for each sound based on the inverted power spectrum.

For example, if a default share ratio that has been created is stored in advance in the memory 22 for each sound, the DSP 21 may, for example, in accordance with the timing when a specific sound is selected by the user or when a specific sound starts to be played, read the default share ratio corresponding to the specific sound from the memory 22, and set the voltage share in accordance with the read share ratio.

Specifically, for example, in a case in which the control device 20 is connected to a music playback device such as a smartphone, a music player, or a car navigation system by wire or wirelessly, the DSP 21 acquires information related to the title and performer of the piece of music that the user is playing. The DSP 21 may identify the piece of music from the acquired title and performer information, read out a default share ratio corresponding to the identified piece of music from the memory 22, and set the voltage share in accordance with the read share ratio.

Further, for example, in a case in which a piece of music is played on a radio, a radio personality may relate information about the title and the performer of the piece of music before playing the piece of music. Therefore, the DSP 21 may use a known voice recognition technique to obtain information about the title and performer of the piece of music that is about to be played, and identify the piece of music from the obtained information. If the radio personality does not relate information about the title and performer of the piece of music before playing the song, the DSP 21 may identify the piece of music from the melody of the piece of music being played. In this case, the DSP 21 itself may execute processing for identifying a piece of music from the melody of the piece of music; however, the piece of music may be identified by using a website that provides a service for identifying a piece of music from the melody of the piece of music.

Further, in a case in which active noise cancellation of a sound whose power spectrum and the position of the sound source cannot be specified in advance, such as noise in areas where vehicles are running, is performed by using the exciter-equipped glass diaphragm 1, since an inverted power spectrum cannot be obtained in advance, the default share ratio of the exciter 3 cannot be created in advance.

Therefore, in such a case, the DSP 21 collects sound with a microphone, sequentially generates an inverted power spectrum from the audio data of the collected sound, and sequentially calculates the share ratio of the exciter 3 based on the generated inverted power spectrum, thereby generating a sequential share ratio.

In the foregoing description, the control processing for the exciter-equipped glass diaphragm 1 has been described using an example in which the exciter 3 generates vibration in the vicinity of the lowest resonant frequency F1(0); however, the same processing can be carried out in a case of causing the exciter 3 to generate vibration at a frequency the vicinity of the lowest resonant frequency F2(0). In this case, in step S20, while reducing the voltage share of the exciter 3B to below the voltage share of the exciter 3A, the DSP 21 may increase the voltage share of the exciter 3A so as to compensate for the extent of the reduction in the voltage share of the exciter 3B.

By the control processing of the exciter-equipped glass diaphragm shown in FIG. 9, the response time of the vibration generated by the exciters 3A and 3B in the vicinity of the lowest resonant frequency F(0) is suppressed to 0.1 sec or less. Moreover, the response time of the vibration generated by the exciter 3A and the exciter 3B in the vicinity of the lowest resonant frequency F(0) is preferably 0.05 sec or less, more preferably 0.01 sec or less, even more preferably 0.005 sec or less, and particularly preferably 0.003 sec or less.

In FIG. 1, an example is shown in which the exciter 3A and the exciter 3B are attached to one end of the region A1 of the glass plate structure 9 along the direction of travel of the vehicle; however, there is no restriction on the attachment position of the exciters 3 in the area A1.

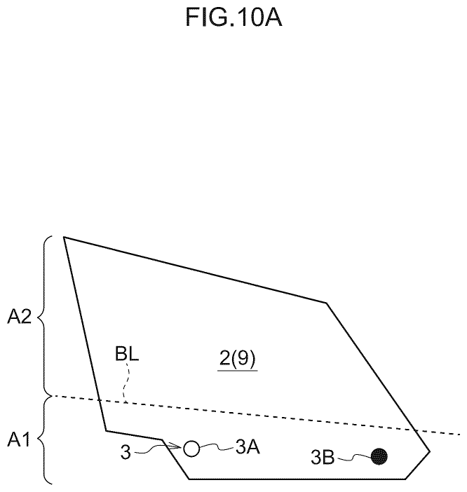

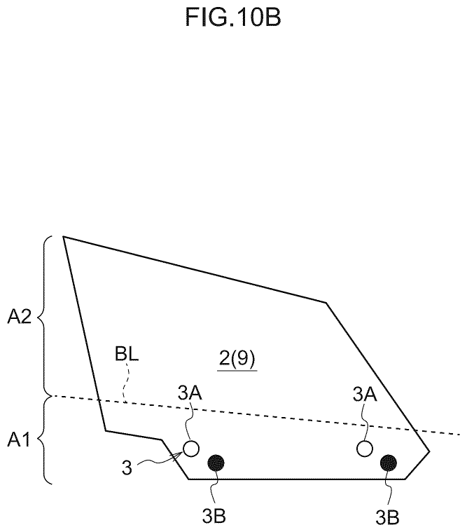

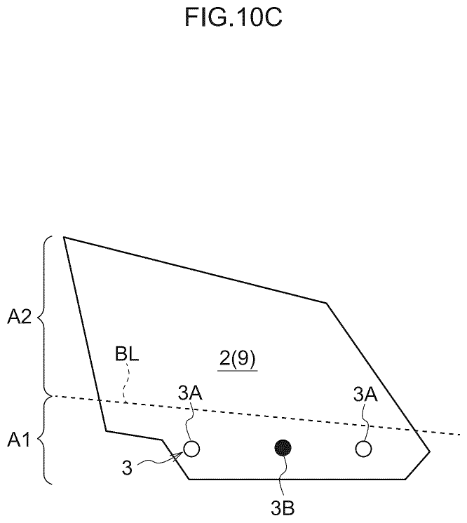

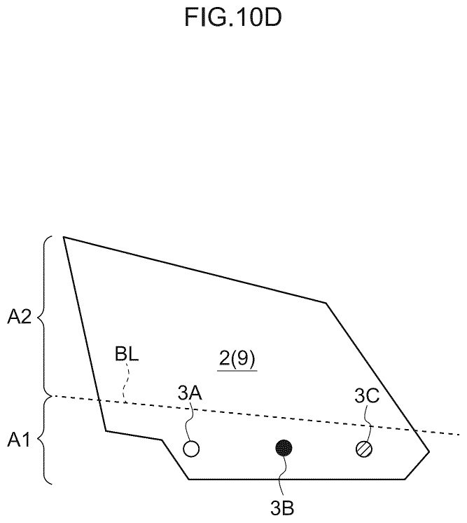

For example, as shown in FIG. 10A, an exciter 3A and an exciter 3B may be attached to respective ends of the area A1 of the glass plate structure 9 along the travel direction of the vehicle.

Moreover, plural exciters 3 having the same lowest resonant frequency F(0) may be attached to the glass plate structure 9. FIG. 10B is a diagram showing an example in which a pair of exciters 3A and 3B is attached to each end along the travel direction of the vehicle in the area A1 of the glass plate structure 9. In this case, in step S30 of FIG. 9, the DSP 21 controls the voltage input to each of the exciters 3A such that the voltage input to each of the exciters 3A becomes the target voltage calculated in step S20. Further, the DSP 21 controls the voltage input to each of the exciters 3B so that the voltage input to each of the exciters 3B becomes the target voltage calculated in step S20.

Furthermore, among the exciters 3 attached to the glass plate structure 9, the numbers of exciters 3 having the same lowest resonant frequency F(0) do not necessarily have to be the same. For example, FIG. 10C is a diagram showing an example of attachment to the glass plate structure 9 in a case in which the number of exciters 3B is smaller than the number of exciters 3A. As shown in FIG. 10C, a set of exciters 3 having the same lowest resonant frequency F(0)—that is, the number of exciters 3 in an exciter group having the same lowest resonant frequency F(0)—may be different for each exciter group.

Furthermore, in the foregoing description, an example is explained in which two types of exciters 3 having different lowest resonant frequencies F(0), exciters 3A and exciters 3B, are attached to the glass plate structure 9; however, three or more types of exciter 3 having different lowest resonant frequencies F(0) may be attached to the glass plate structure 9. FIG. 10D is a diagram showing an example of attaching three types of exciter 3A, 3B, and 3C having different lowest resonant frequencies F(0) to the glass plate structure 9. In a case in which vibration having a frequency in the vicinity of any of the lowest resonant frequencies F(0) is to be generated at the exciter 3, the DSP 21 reduces the voltage share of the exciter 3 having the lowest resonant frequency F(0) that is the generation target to lower than the voltage share of the other exciters 3. In addition, the DSP 21 performs control to increase the voltage shares of the other exciters 3 so as to compensate for the amount of the reduction in the voltage share of the exciter having the lowest resonant frequency F(0) that is the generation target.

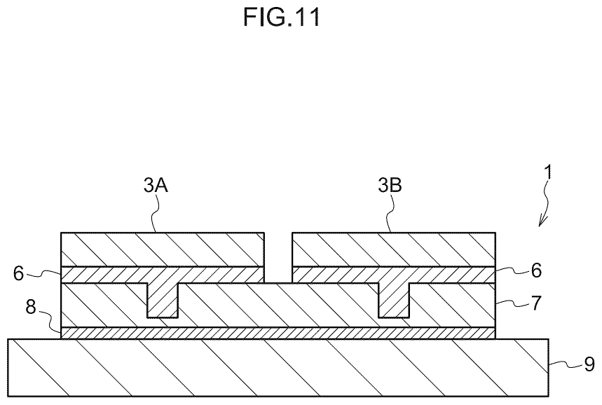

In addition, in a case in which the exciter 3 is attached to the glass plate structure 9, as shown in FIG. 2, it is attached to the glass plate structure 9 via a mount 7 provided on one of the main surfaces of the glass plate structure 9; however, plural exciters 3 may be attached to one mount 7. FIG. 11 is a diagram showing an example in which two exciters 3 are fixed to one mount 7 and spaced apart from each other. While a dedicated mount 7 for attaching the exciter 3 to the glass plate structure 9 may be provided, in a case in which the glass plate structure 9 is already provided with a structure that can be used as the mount 7, this structure may be used as the mount 7.

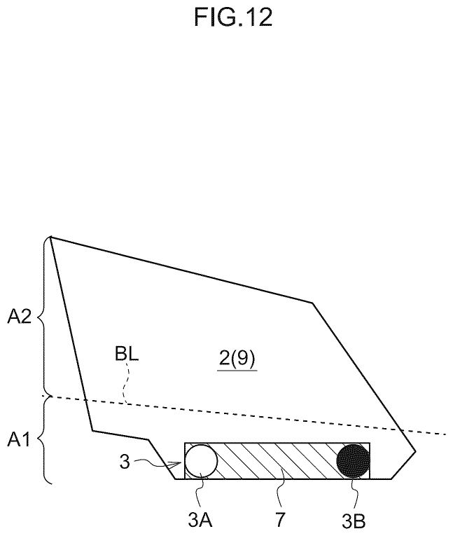

FIG. 12 is a diagram showing a use example in which a structure attached to a glass plate structure 9 is used as the mount 7. In the example shown in FIG. 12, a structure (holder) that is attached in advance to the glass plate structure 9 in order to slide the glass plate structure 9 in response to a switch operation by a user, is utilized as the mount 7. The mount 7 in FIG. 12 is U-shaped, and holds the glass plate structure 9 in the gap of the U-shape so as to support the glass plate structure 9 from below. A support member (not shown) that is moved up and down by the rotation of a motor that is coupled to a switch operation is attached below the mount 7 in FIG. 12. Owing to the support member moving upward, the entire glass plate structure 9 moves upward, and the opening area of the vehicle assumes a fully closed state due to the glass plate structure 9. Furthermore, owing to the support material moving downward, the entire glass plate structure 9 moves below the belt line BL, and the opening area of the vehicle assumes a fully open state. The exciter 3 is attached to the mount 7 using the structure that is used to slide the glass plate structure 9 in this way. Here, a new mount 7 for attaching the exciter 3 to the glass plate structure 9 may be unnecessary.

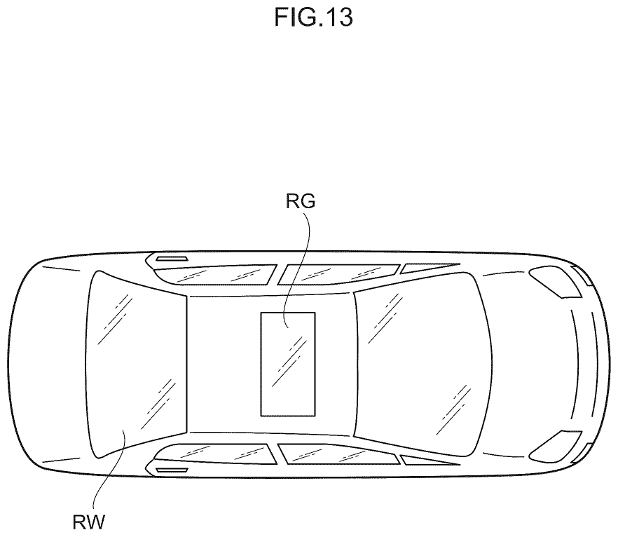

In the foregoing description, the exciter-equipped glass diaphragm 1 is explained using an example in which the exciter 3 is attached to the side glass of a vehicle; however, as shown in FIG. 13, the exciter-equipped glass diaphragm 1 may be applied to at least one of the roof glass RG or the back door glass RW of a vehicle.

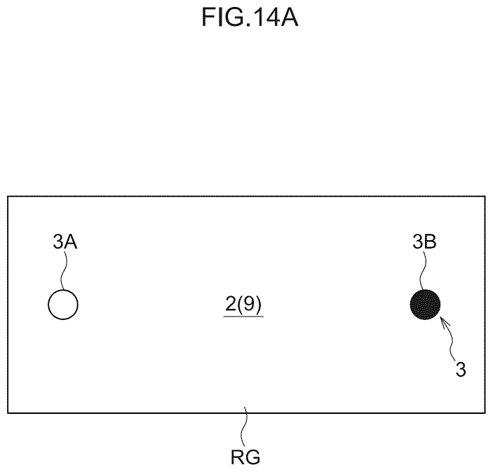

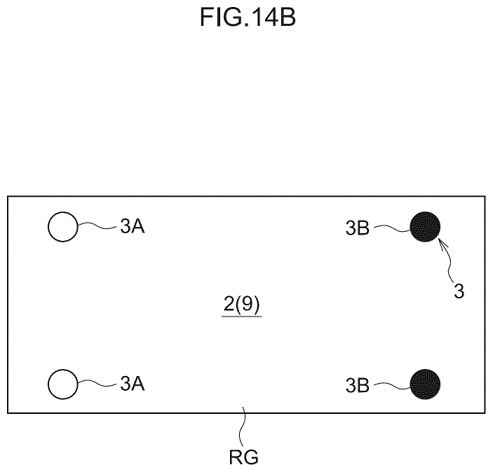

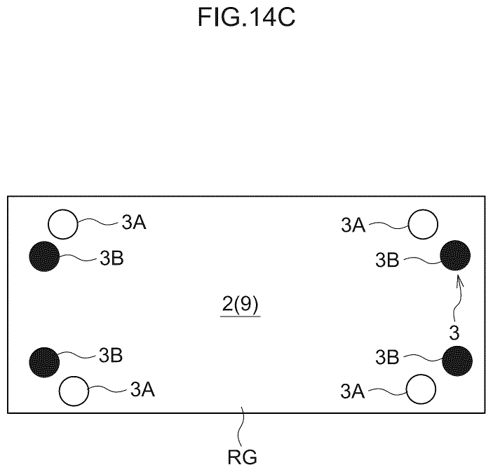

FIGS. 14A to 14C are diagrams showing attachment examples of exciters to roof glass.

Of these, FIG. 14A shows an example in which an exciter 3A is attached in the vicinity of one of opposite sides of a roof glass RG, and an exciter 3B is attached in the vicinity of the other side.

FIG. 14B shows an example in which one exciter 3A is attached to each of two of the four corners of the roof glass RG, and one exciter 3B is attached to each of the remaining two corners. Here, there are no restrictions on the attachment positions of the exciters 3, such as to which two of the four corners of the roof glass RG the exciters 3A are attached and to which two corners the exciters 3B are attached.

FIG. 14C shows an example in which a pair of exciters, each consisting of an exciter 3A and an exciter 3B, is attached to each of the four corners of the roof glass RG.

The numbers of exciters 3A and 3B attached to the roof glass RG do not necessarily have to be the same and, for example, an exciter 3A or an exciter 3B may be added near the center of the roof glass RG where two diagonal lines of the roof glass RG shown in FIG. 14B intersect.

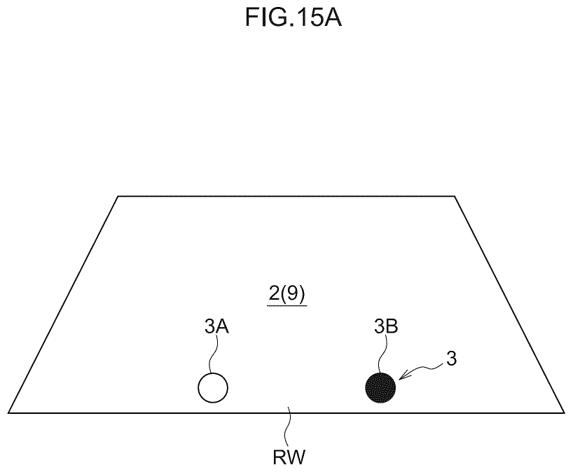

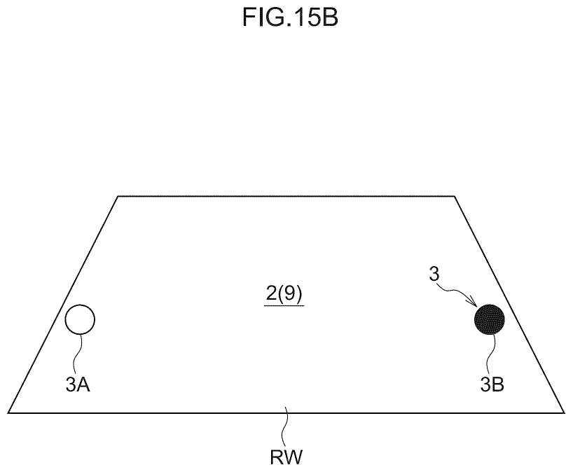

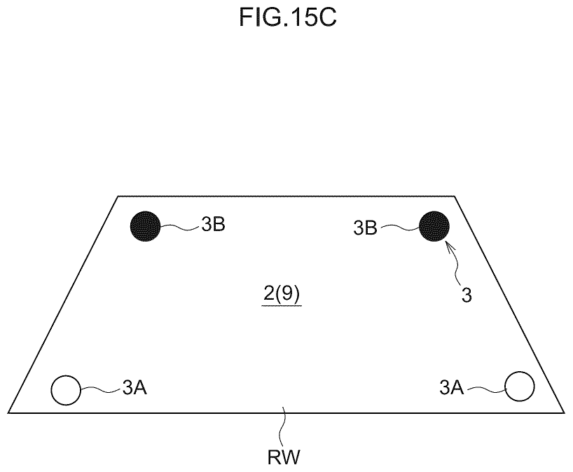

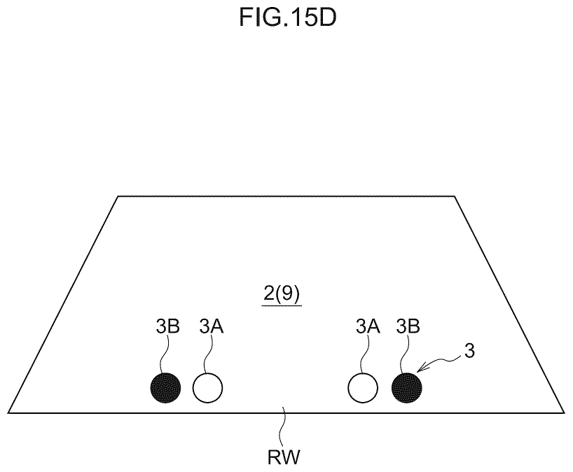

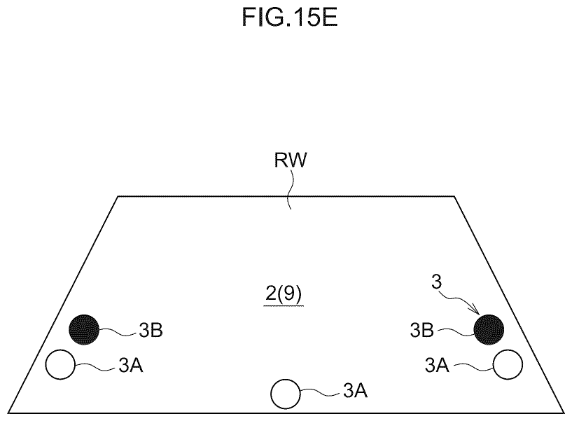

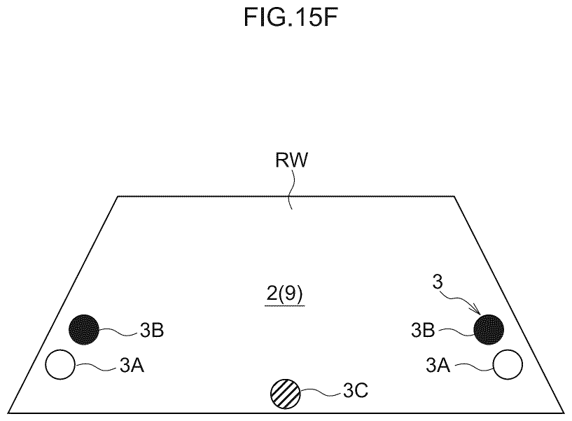

Further, FIGS. 15A to 15F are diagrams showing attachment examples of exciters to back door glass RW.

Of these, FIG. 15A shows an example in which one exciter 3A and one exciter 3B are attached along one side of the back door glass RW.

FIG. 15B shows an example in which an exciter 3A is attached in the vicinity of one of opposite sides of the back door glass RW, and an exciter 3B is attached in the vicinity of the other side.

FIG. 15C shows an example in which one exciter 3A is attached to each of two of the four corners of the back door glass RW, and one exciter 3B is attached to each of the remaining two corners. As in the case of the roof glass RG, there is no restriction on the attachment position of the exciters 3 in terms of to which two corners the exciters 3A are attached among the four corners of the back door glass RW, and to which two corners the exciters 3B are attached.

FIG. 15D shows an example in which two exciter pairs, each consisting of an exciter 3A and an exciter 3B, are attached along one side of the back door glass RW.

FIG. 15E shows an example in which an exciter pair is attached in the vicinity of each of opposite sides of the back door glass RW, and an exciter 3A is attached in the vicinity of one of the remaining sides.

FIG. 15F shows an attachment example in which the exciter 3A attached in the vicinity of the remaining side in FIG. 15E is replaced with an exciter 3C. In this way, three or more types of exciters 3 each having a different lowest resonant frequency F(0) may be attached to the roof glass RG and the back door glass RW.

In this way, the matter of how many exciters 3 having what kind of lowest resonant frequency F(0) to attach to which position of the glass used in which part of the vehicle, including the side glass, roof glass RG, and back door glass RW, is determined, for example, taking into consideration the vibration characteristics of the glass plate structure 9, the frequency characteristics of the exciter 3, and the acoustic characteristics inside the vehicle.

Further, although an example of applying the exciter-equipped glass diaphragm 1 to a vehicle has been described thus far, the exciter-equipped glass diaphragm 1 may be applied to glass used in moving objects such as trains, drones, airplanes, and ships, as well as to window glass for building construction.

The exciter-equipped glass diaphragm 1 may also be applied to a partition that separates people from one another. Specifically, the exciter-equipped glass diaphragm 1 may be applied to ticket sales booths in theaters, zoos, art museums, amusement parks, and the like, to bank counters, to train station counters, and in front of convenience store cash registers. The exciter-equipped glass diaphragm 1 may also be applied to partitions separating individual seats in first class on an airplane.

In addition, in order to attenuate sounds emitted from inside a machine or device, or in order to emit sounds from a machine or device, the exciter-equipped glass diaphragm 1 may be applied to a glass portion of the casing of a machine or device.

In addition, in order to attenuate sound that penetrates from the outside space to the inside space of a glass insulation wall (soundproof wall) installed on the side of the road, the exciter-equipped glass diaphragm 1 may be applied to a glass portion of the sound insulation wall (soundproof wall).

Above, one aspect of the control system 10 for an exciter-equipped glass diaphragm has been described using an embodiment; however, the disclosed embodiment of the control system 10 for an exciter-equipped glass diaphragm is an example, and the configuration of the control system 10 for an exciter-equipped glass diaphragm is not limited to the range described in the embodiment. Various modifications and improvements may be made to the exemplary embodiments within a range not departing from the gist of the present disclosure, and embodiments including these modifications and improvements are included within the technical scope of the present disclosure. For example, additional processing may be added to the exciter-equipped glass diaphragm control processing shown in FIG. 9 within a range not departing from the gist of the present disclosure.

Further, in the above-described embodiments, the exciter-equipped glass diaphragm control processing shown in FIG. 9 is implemented by software, as an example. However, the same processing as that shown in the flow chart of the control processing for the exciter-equipped glass diaphragm may be performed by hardware. In this case, the processing speed can be increased as compared to when the control processing for the exciter-equipped glass diaphragm is implemented by software.

In the above-described embodiments, the processor refers to a processor in a broad sense, and includes, for example, the DSP 21 or a dedicated processor. Dedicated processors include, for example, graphics processing units (GPUs), application specific integrated circuits (ASICs), field programmable gate arrays (FPGAs), and programmable logic devices.

Furthermore, the operations of the processor in the above-described embodiments may not only be performed by a single processor, but may also be performed by plural processors located at physically separate locations working together.

In the above-described embodiments, an example is described in which the non-volatile memory configuring the memory 22 stores an exciter-equipped glass diaphragm control program; however, the storage location of the exciter-equipped glass diaphragm control program is not limited to a non-volatile memory. The exciter-equipped glass diaphragm control program of the present disclosure can also be provided in a format recorded on a computer-readable storage medium. For example, exciter-equipped glass diaphragm control program may be provided in a form recorded on an optical disc such as a CD-ROM (compact disk read-only memory), a DVD-ROM (digital versatile disk read-only memory), or a Blu-ray disc. In addition, the exciter-equipped glass diaphragm control program may be provided in a format recorded on a portable semiconductor memory such as a USB (universal serial bus) memory or a memory card. Non-volatile memories, CD-ROMs, DVD-ROMs, Blu-ray discs, USBs, and memory cards are examples of non-transitory storage media.

Furthermore, the control device 20 may download a control program for an exciter-equipped glass diaphragm from an external device connected to the Internet via a communication unit (not shown), and store the program in a non-volatile memory.

As described above, the present specification discloses the following features.

(1) An exciter-equipped glass diaphragm, including:
a glass plate structure; and
a first exciter and a second exciter, which are attached to the glass plate structure,
in which, when a lowest resonant frequency of the first exciter is F1(0) (Hz), and
a lowest resonant frequency of the second exciter is F2(0) (Hz),
the exciter-equipped glass diaphragm satisfies:

$$3 \leq \vert F 1 ( 0 ) - F 2 ( 0 ) \vert \leq 100 ( Hz ) .$$

According to this exciter-equipped glass diaphragm, since one exciter can generate vibrations at a frequency that corresponds to the lowest resonant frequency of the other exciter, acoustic properties can be obtained over a wide acoustic range that has favorable reproducibility for acoustic ranges in the vicinity of the exciter's intrinsic lowest resonant frequency.

(2) The exciter-equipped glass diaphragm of (1), in which each of the lowest resonant frequency F1(0) of the first exciter and the lowest resonant frequency F2(0) of the second exciter is 200 Hz or lower.

According to this exciter-equipped glass diaphragm, by using an exciter with a lowest resonant frequency of 200 Hz or lower, compared to a case in which the lowest resonant frequency exceeds 200 Hz, it is possible to generate sound in the lowest possible bass range.

(3) The exciter-equipped glass diaphragm of(1) or (2), in which the first exciter and the second exciter are fixed to the glass plate structure at a distance from each other via a single mount provided at one main surface of the glass plate structure.

According to this exciter-equipped glass diaphragm, since multiple exciters are fixed to the same mount, compared to a case in which a mount is provided for each exciter, the number of mounts can be reduced.

(4) The exciter-equipped glass diaphragm of any one of (1) to (3), in which the glass plate structure is vehicle window glass.

According to this exciter-equipped glass diaphragm, noise entering the car via window glass can be reduced.

(5) The exciter-equipped glass diaphragm of any one of (1) to (3), in which the glass plate structure is glass that is used for at least one of a moving body, a building, a partition separating individual persons, a casing of a device, or a soundproof wall.

According to this exciter-equipped glass diaphragm, application to any object in which glass is used is possible.

(6) A control system for an exciter-equipped glass diaphragm, the system including:
an exciter-equipped glass diaphragm, including a glass plate structure, and a first exciter and a second exciter, which are attached to the glass plate structure, in which, when a lowest resonant frequency of the first exciter is F1(0) (Hz), and a lowest resonant frequency of the second exciter is F2(0) (Hz), the exciter-equipped glass diaphragm satisfies:

3≤|F1(0)−F2(0)|≤100 (Hz); and
a control device configured to control a voltage input to each of the first exciter and the second exciter so as to:
   reduce the voltage input to the first exciter required for the first exciter to generate vibration at a frequency in the vicinity of the lowest resonant frequency F1(0) of the first exciter to lower than the voltage input to the second exciter required for the second exciter to generate vibration at a frequency in the vicinity of the lowest resonant frequency F1(0) of the first exciter, and, in conjunction with reducing the voltage input to the first exciter, increase the voltage input to the second exciter corresponding to the lowest resonant frequency F1(0) of the first exciter so as to compensate for an amount of reduction from vibration at a frequency in the vicinity of the lowest resonant frequency F1(0) of the first exciter that was planned to be generated by the first exciter; and
   reduce the voltage input to the second exciter corresponding to the vicinity of the lowest resonant frequency F2(0) of the second exciter required for the second exciter to generate vibration at a frequency in the vicinity of the lowest resonant frequency F2(0) of the second exciter to lower than the voltage input to the first exciter corresponding to the vicinity of the lowest resonant frequency F2(0) of the second exciter required for the first exciter to generate vibration at a frequency in the vicinity of the lowest resonant frequency F2(0) of the second exciter, and, in conjunction with reducing the voltage input to the second exciter, increase the voltage input to the first exciter corresponding to the lowest resonant frequency F2(0) of the second exciter so as to compensate for an amount of reduction from vibration at a frequency in the vicinity of the lowest resonant frequency F2(0) of the second exciter that was planned to be generated by the first exciter.

According to this glass diaphragm control system, since one exciter can generate vibrations at a frequency that corresponds to the lowest resonant frequency of the other exciter, acoustic properties can be obtained over a wide acoustic range that has favorable reproducibility for acoustic ranges in the vicinity of the exciter's intrinsic lowest resonant frequency.

(7) The control system for an exciter-equipped glass diaphragm of (6), in which each of the lowest resonant frequency F1(0) of the first exciter and the lowest resonant frequency F2(0) of the second exciter is 200 Hz or lower.

According to this glass diaphragm control system, by using an exciter with a lowest resonant frequency of 200 Hz or lower, compared to a case in which the lowest resonant frequency exceeds 200 Hz, it is possible to generate sound in the lowest possible bass range.

(8) The control system for an exciter-equipped glass diaphragm of (6) or (7), in which:
each of the lowest resonant frequency F1(0) of the first exciter and the lowest resonant frequency F2(0) of the second exciter includes a predetermined frequency band of from 20 Hz to 200 Hz, and
the control device controls the voltage input to each of the first exciter and the second exciter so as to maintain, within a predetermined range in which a variation amount of the first exciter and a variation amount of the second exciter can be regarded as having the same magnitude, a difference in the respective variation amounts of the voltage input to the first exciter and the voltage input to the second exciter from a voltage share determined in advance as the voltage input to the first exciter and the voltage input to the second exciter for generating acceleration of a magnitude corresponding to each frequency in the predetermined frequency band.

According to this glass diaphragm control system, compared to a case in which exciters having a lowest resonant frequency in excess of 200 Hz are used, it is possible to generate sound in the lowest possible bass range. Further, according to this glass diaphragm control system, the vibration of one exciter at a frequency corresponding to the lowest resonant frequency can be compensated for by the vibration of the other exciter.

(9) The control system for an exciter-equipped glass diaphragm of (8), in which the control device inputs voltage in a range of from 0.01 V to 100 V to the first exciter and the second exciter.

According to this glass diaphragm control system, the voltage input to each exciter can be limited to within a predetermined range.

(10) The control system for an exciter-equipped glass diaphragm of any one of (6) to (9), in which, in a state in which voltage input has been applied to the first exciter and the second exciter:
in the first exciter, a difference between a target voltage of the control device when a vibration frequency of the first exciter is the lowest resonant frequency F1(0) and a target voltage of the control device when the vibration frequency of the first exciter is the lowest resonant frequency F1(0)−3 Hz is 20 V or less, and a difference between a target voltage of the control device when the vibration frequency of the first exciter is the lowest resonant frequency F1(0) and a target voltage of the control device when the vibration frequency of the first exciter is the lowest resonant frequency F1(0)+3 Hz is 20 V or less; or
in the second exciter, a difference between a target voltage of the control device when a vibration frequency of the second exciter is the lowest resonant frequency F2(0) and a target voltage of the control device when the vibration frequency of the second exciter is the lowest resonant frequency F2(0)−3 Hz is 20 V or less, and a difference between a target voltage of the control device when the vibration frequency of the second exciter is the lowest resonant frequency F2(0) and a target voltage of the control device when the vibration frequency of the second exciter is the lowest resonant frequency F2(0)+3 Hz is 20 V or less.

According to this glass diaphragm control system, compared to a case in which no limit is placed on the difference between the target voltages at each vibration frequency, favorable sound can be reproduced in the vicinity of the lowest resonant frequency.

(11) The control system for an exciter-equipped glass diaphragm of any one of (6) to (10), in which the control device controls the voltage input to each of the first exciter and the second exciter such that a response time of vibration generated by the first exciter and the second exciter is 0.1 sec or less in a frequency band in the vicinity of the lowest resonant frequency F1(0) of the first exciter and in the vicinity of the lowest resonant frequency F2(0) of the second exciter.

According to this glass diaphragm control system, it is possible to suppress deterioration in sound reproducibility caused by delays in the response time of the exciter.

(12) A control program for an exciter-equipped glass diaphragm, for causing a computer to execute processing including:
with respect to a first exciter and a second exciter attached to a glass plate structure configuring an exciter-equipped glass diaphragm, which, when respective lowest resonant frequencies of the first exciter and the second exciter are F1(0) and F2(0), satisfy.

$$3 \leq \vert F 1 ( 0 ) - F 2 ( 0 ) \vert \leq 100 ( Hz ) ,$$

reducing the voltage input to the first exciter required for the first exciter to generate vibration at a frequency in the vicinity of the lowest resonant frequency F1(0) of the first exciter to lower than the voltage input to the second exciter required for the second exciter to generate vibration at a frequency in the vicinity of the lowest resonant frequency F1(0) of the first exciter, and, in conjunction with reducing the voltage input to the first exciter, increasing the voltage input to the second exciter corresponding to the lowest resonant frequency F1(0) of the first exciter so as to compensate for an amount of reduction from vibration at a frequency in the vicinity of the lowest resonant frequency F1(0) of the first exciter that was planned to be generated by the first exciter; and
reducing the voltage input to the second exciter corresponding to the vicinity of the lowest resonant frequency F2(0) of the second exciter required for the second exciter to generate vibration at a frequency in the vicinity of the lowest resonant frequency F2(0) of the second exciter to lower than the voltage input to the first exciter corresponding to the vicinity of the lowest resonant frequency F2(0) of the second exciter required for the first exciter to generate vibration at a frequency in the vicinity of the lowest resonant frequency F2(0) of the second exciter, and, in conjunction with reducing the voltage input to the second exciter, increasing the voltage input to the first exciter corresponding to the lowest resonant frequency F2(0) of the second exciter so as to compensate for an amount of reduction from vibration at a frequency in the vicinity of the lowest resonant frequency F2(0) of the second exciter that was planned to be generated by the first exciter.

According to this glass diaphragm control program, one exciter can generate vibrations at a frequency that corresponds to the lowest resonant frequency of the other. Therefore, according to this glass diaphragm control program, it is possible to realize an exciter-equipped glass diaphragm that has acoustic properties over a broad acoustic range that renders favorable the reproducibility of an acoustic range in the vicinity of the lowest resonant frequency specific to the exciters.

(13) The control program for an exciter-equipped glass diaphragm of (12), for causing the computer to execute processing including controlling the voltage input to each of the first exciter and the second exciter, at which each of the lowest resonant frequency F1(0) and the lowest resonant frequency F2(0) is 200 Hz or lower.

According to this glass diaphragm control program, the voltage input to exciters having a lowest resonant frequency of 200 Hz or less is controlled. Therefore, according to this glass diaphragm control program, compared to a case in which a control device controls the voltage input to an exciter having a lowest resonant frequency in excess of 200 Hz, it is possible to generate sound in the lowest possible bass range.

(14) The control program for an exciter-equipped glass diaphragm of (12) or (13), for causing a computer to execute processing including:
with respect to the first exciter and the second exciter, at which each of the lowest resonant frequency F1(0) and the lowest resonant frequency F2(0) includes a predetermined frequency band of from 20 Hz to 200 Hz,
controlling the voltage input to each of the first exciter and the second exciter so as to maintain, within a predetermined range in which a variation amount of the first exciter and a variation amount of the second exciter can be regarded as having the same magnitude, a difference in the respective variation amounts of the voltage input to the first exciter and the voltage input to the second exciter from a voltage share determined in advance as the voltage input to the first exciter and the voltage input to the second exciter for generating acceleration of a magnitude corresponding to each frequency in the predetermined frequency band.

According to this glass diaphragm control program, compared to a case in which the voltage input to an exciter having a lowest resonant frequency of 200 Hz is controlled, it is possible to generate sound in the lowest possible bass range. Further, according to this glass diaphragm control program, the vibration of one exciter at a frequency corresponding to the lowest resonant frequency can be compensated for by the vibration of the other exciter.

(15) The control program for an exciter-equipped glass diaphragm of (14), for causing the computer to execute processing including effecting control such that a range of the voltage input to each of the first exciter and the second exciter is from 0.01 V to 100 V.

According to this glass diaphragm control program, the voltage input to each exciter can be limited to within a predetermined range.

(16) The control program for an exciter-equipped glass diaphragm of any one of (12) to (15), for causing the computer to execute processing including causing voltage to be generated such that, in a state in which voltage input has been applied to the first exciter and the second exciter by a control device:
in the first exciter, a difference between a target voltage of the control device when a vibration frequency of the first exciter is the lowest resonant frequency F1(0) and a target voltage of the control device when the vibration frequency of the first exciter is the lowest resonant frequency F1(0)−3 Hz is 20 V or less, and a difference between a target voltage of the control device when the vibration frequency of the first exciter is the lowest resonant frequency F1(0) and a target voltage of the control device when the vibration frequency of the first exciter is the lowest resonant frequency F1(0)+3 Hz is 20 V or less; or
in the second exciter, a difference between a target voltage of the control device when a vibration frequency of the second exciter is the lowest resonant frequency F2(0) and a target voltage of the control device when the vibration frequency of the second exciter is the lowest resonant frequency F2(0)−3 Hz is 20 V or less, and a difference between a target voltage of the control device when the vibration frequency of the second exciter is the lowest resonant frequency F2(0) and a target voltage of the control device when the vibration frequency of the second exciter is the lowest resonant frequency F2(0)+3 Hz is 20 V or less.

According to this glass diaphragm control program, compared to a case in which no limit is placed on the difference between the target voltages at each vibration frequency, favorable sound can be reproduced in the vicinity of the lowest resonant frequency.

(17) The control program for an exciter-equipped glass diaphragm of any one of (12) to (16), for causing a computer to execute processing including controlling the voltage input to each of the first exciter and the second exciter such that a response time of vibration generated by the first exciter and the second exciter is 0.1 sec or less in a frequency band in the vicinity of the lowest resonant frequency F1(0) of the first exciter and in the vicinity of the lowest resonant frequency F2(0) of the second exciter.

According to this glass diaphragm control program, it is possible to suppress deterioration in sound reproducibility caused by delays in the response time of the exciter.

The disclosure of Japanese Patent Application No. 2022-157157 filed on Sep. 29, 2022, is incorporated herein by reference in its entirety. All documents, patent applications, and technical standards described in the present specification are incorporated by reference in the present specification to the same extent as if the individual documents, patent applications, and technical standards were specifically and individually stated to be incorporated by reference.

What is claimed is:

1. An exciter-equipped glass diaphragm, comprising:
a glass plate structure; and
a first exciter and a second exciter, which are attached to the glass plate structure,
wherein, when a lowest resonant frequency of the first exciter is F1(0) (Hz), and
a lowest resonant frequency of the second exciter is F2(0) (Hz),
the exciter-equipped glass diaphragm satisfies:
$$3 \leq \vert F 1 ( 0 ) - F 2 ( 0 ) \vert \leq 100 ( Hz ) .$$

2. The exciter-equipped glass diaphragm of claim 1, wherein each of the lowest resonant frequency F1(0) of the first exciter and the lowest resonant frequency F2(0) of the second exciter is 200 Hz or lower.

3. The exciter-equipped glass diaphragm of claim 1, wherein the first exciter and the second exciter are fixed to the glass plate structure at a distance from each other via a single mount provided at one main surface of the glass plate structure.

4. The exciter-equipped glass diaphragm of claim 1, wherein the glass plate structure is vehicle window glass.

5. The exciter-equipped glass diaphragm of claim 1, wherein the glass plate structure is glass that is used for at least one of a moving body, a building, a partition separating individual persons, a casing of a device, or a soundproof wall.

6. A control system for an exciter-equipped glass diaphragm, the system comprising:
an exciter-equipped glass diaphragm, including a glass plate structure, and a first exciter and a second exciter, which are attached to the glass plate structure, wherein, when a lowest resonant frequency of the first exciter is F1(0) (Hz), and a lowest resonant frequency of the second exciter is F2(0) (Hz), the exciter-equipped glass diaphragm satisfies:
3≤|F1(0)−F2(0)|≤100 (Hz); and
a control device configured to control a voltage input to each of the first exciter and the second exciter so as to:
reduce the voltage input to the first exciter required for the first exciter to generate vibration at a frequency in the vicinity of the lowest resonant frequency F1(0) of the first exciter to lower than the voltage input to the second exciter required for the second exciter to generate vibration at a frequency in the vicinity of the lowest resonant frequency F1(0) of the first exciter, and, in conjunction with reducing the voltage input to the first exciter, increase the voltage input to the second exciter corresponding to the lowest resonant frequency F1(0) of the first exciter so as to compensate for an amount of reduction from vibration at a frequency in the vicinity of the lowest resonant frequency F1(0) of the first exciter that was planned to be generated by the first exciter; and
reduce the voltage input to the second exciter corresponding to the vicinity of the lowest resonant frequency F2(0) of the second exciter required for the second exciter to generate vibration at a frequency in the vicinity of the lowest resonant frequency F2(0) of the second exciter to lower than the voltage input to the first exciter corresponding to the vicinity of the lowest resonant frequency F2(0) of the second exciter required for the first exciter to generate vibration at a frequency in the vicinity of the lowest resonant frequency F2(0) of the second exciter, and, in conjunction with reducing the voltage input to the second exciter, increase the voltage input to the first exciter corresponding to the lowest resonant frequency F2(0) of the second exciter so as to compensate for an amount of reduction from vibration at a frequency in the vicinity of the lowest resonant frequency F2(0) of the second exciter that was planned to be generated by the first exciter.

7. The control system for an exciter-equipped glass diaphragm of claim 6, wherein each of the lowest resonant frequency F1(0) of the first exciter and the lowest resonant frequency F2(0) of the second exciter is 200 Hz or lower.

8. The control system for an exciter-equipped glass diaphragm of claim 6, wherein:
each of the lowest resonant frequency F1(0) of the first exciter and the lowest resonant frequency F2(0) of the second exciter includes a predetermined frequency band of from 20 Hz to 200 Hz, and
the control device controls the voltage input to each of the first exciter and the second exciter so as to maintain, within a predetermined range in which a variation amount of the first exciter and a variation amount of the second exciter can be regarded as having the same magnitude, a difference in the respective variation amounts of the voltage input to the first exciter and the voltage input to the second exciter from a voltage share determined in advance as the voltage input to the first exciter and the voltage input to the second exciter for generating acceleration of a magnitude corresponding to each frequency in the predetermined frequency band.

9. The control system for an exciter-equipped glass diaphragm of claim 8, wherein the control device inputs voltage in a range of from 0.01 V to 100 V to the first exciter and the second exciter.

10. The control system for an exciter-equipped glass diaphragm of claim 6, wherein, in a state in which voltage input has been applied to the first exciter and the second exciter:
in the first exciter, a difference between a target voltage of the control device when a vibration frequency of the first exciter is the lowest resonant frequency F1(0) and a target voltage of the control device when the vibration frequency of the first exciter is the lowest resonant frequency F1(0)−3 Hz is 20 V or less, and a difference between a target voltage of the control device when the vibration frequency of the first exciter is the lowest resonant frequency F1(0) and a target voltage of the control device when the vibration frequency of the first exciter is the lowest resonant frequency F1(0)+3 Hz is 20 V or less; or
in the second exciter, a difference between a target voltage of the control device when a vibration frequency of the second exciter is the lowest resonant frequency F2(0) and a target voltage of the control device when the vibration frequency of the second exciter is the lowest resonant frequency F2(0)−3 Hz is 20 V or less, and a difference between a target voltage of the control device when the vibration frequency of the second exciter is the lowest resonant frequency F2(0) and a target voltage of the control device when the vibration frequency of the second exciter is the lowest resonant frequency F2(0)+3 Hz is 20 V or less.

11. The control system for an exciter-equipped glass diaphragm of claim 6, wherein the control device controls the voltage input to each of the first exciter and the second exciter such that a response time of vibration generated by the first exciter and the second exciter is 0.1 sec or less in a frequency band in the vicinity of the lowest resonant frequency F1(0) of the first exciter and in the vicinity of the lowest resonant frequency F2(0) of the second exciter.

12. A non-transitory computer-readable storage medium storing a control program for an exciter-equipped glass diaphragm, for causing a computer to execute processing comprising:
with respect to a first exciter and a second exciter attached to a glass plate structure configuring an exciter-equipped glass diaphragm, which, when respective lowest resonant frequencies of the first exciter and the second exciter are F1(0) and F2(0), satisfy:
$$3 \leq \vert F 1 ( 0 ) - F 2 ( 0 ) \vert \leq 100 ( Hz ) ,$$
reducing the voltage input to the first exciter required for the first exciter to generate vibration at a frequency in the vicinity of the lowest resonant frequency F1(0) of the first exciter to lower than the voltage input to the second exciter required for the second exciter to generate vibration at a frequency in the vicinity of the lowest resonant frequency F1(0) of the first exciter, and, in conjunction with reducing the voltage input to the first exciter, increasing the voltage input to the second exciter corresponding to the lowest resonant frequency F1(0) of the first exciter so as to compensate for an amount of reduction from vibration at a frequency in the vicinity of the lowest resonant frequency F1(0) of the first exciter that was planned to be generated by the first exciter; and
reducing the voltage input to the second exciter corresponding to the vicinity of the lowest resonant frequency F2(0) of the second exciter required for the second exciter to generate vibration at a frequency in the vicinity of the lowest resonant frequency F2(0) of the second exciter to lower than the voltage input to the first exciter corresponding to the vicinity of the lowest resonant frequency F2(0) of the second exciter required for the first exciter to generate vibration at a frequency in the vicinity of the lowest resonant frequency F2(0) of the second exciter, and, in conjunction with reducing the voltage input to the second exciter, increasing the voltage input to the first exciter corresponding to the lowest resonant frequency F2(0) of the second exciter so as to compensate for an amount of reduction from vibration at a frequency in the vicinity of the lowest resonant frequency F2(0) of the second exciter that was planned to be generated by the first exciter.

13. The computer-readable storage medium of claim 12, for causing the computer to execute processing comprising controlling the voltage input to each of the first exciter and the second exciter, at which each of the lowest resonant frequency F1(0) and the lowest resonant frequency F2(0) is 200 Hz or lower.

14. The computer-readable storage medium of claim 12, for causing a computer to execute processing comprising:
with respect to the first exciter and the second exciter, at which each of the lowest resonant frequency F1(0) and the lowest resonant frequency F2(0) includes a predetermined frequency band of from 20 Hz to 200 Hz,
controlling the voltage input to each of the first exciter and the second exciter so as to maintain, within a predetermined range in which a variation amount of the first exciter and a variation amount of the second exciter can be regarded as having the same magnitude, a difference in the respective variation amounts of the voltage input to the first exciter and the voltage input to the second exciter from a voltage share determined in advance as the voltage input to the first exciter and the voltage input to the second exciter for generating acceleration of a magnitude corresponding to each frequency in the predetermined frequency band.

15. The computer-readable storage medium of claim 14, for causing the computer to execute processing comprising effecting control such that a range of the voltage input to each of the first exciter and the second exciter is from 0.01 V to 100 V.

16. The computer-readable storage medium of claim 12, for causing the computer to execute processing comprising causing voltage to be generated such that, in a state in which voltage input has been applied to the first exciter and the second exciter by a control device:
in the first exciter, a difference between a target voltage of the control device when a vibration frequency of the first exciter is the lowest resonant frequency F1(0) and a target voltage of the control device when the vibration frequency of the first exciter is the lowest resonant frequency F1(0)−3 Hz is 20 V or less, and a difference between a target voltage of the control device when the vibration frequency of the first exciter is the lowest resonant frequency F1(0) and a target voltage of the control device when the vibration frequency of the first exciter is the lowest resonant frequency F1(0)+3 Hz is 20 V or less; or
in the second exciter, a difference between a target voltage of the control device when a vibration frequency of the second exciter is the lowest resonant frequency F2(0) and a target voltage of the control device when the vibration frequency of the second exciter is the lowest resonant frequency F2(0)−3 Hz is 20 V or less, and a difference between a target voltage of the control device when the vibration frequency of the second exciter is the lowest resonant frequency F2(0) and a target voltage of the control device when the vibration frequency of the second exciter is the lowest resonant frequency F2(0)+3 Hz is 20 V or less.

17. The computer-readable storage medium of claim 12, for causing a computer to execute processing comprising controlling the voltage input to each of the first exciter and the second exciter such that a response time of vibration generated by the first exciter and the second exciter is 0.1 sec or less in a frequency band in the vicinity of the lowest resonant frequency F1(0) of the first exciter and in the vicinity of the lowest resonant frequency F2(0) of the second exciter.
